(19) United States
(12) Patent Application Publication
(10) Pub. No.: US 2024/0361482 A1
(43) Pub. Date: Oct. 31, 2024

(54) ESTIMATING MATERIAL PROPERTIES USING PROXY MODELS

(71) Applicant: Halliburton Energy Services, Inc., Houston, TX (US)

(72) Inventors: Xusong WANG, Singapore (SG); Christopher Michael Jones, Houston, TX (US); Xiang Wu, Singapore (SG); Jichun Sun, Singapore (SG); Ho Yin Ma, Singapore (SG)

(73) Assignee: Halliburton Energy Services, Inc., Houston, TX (US)

(21) Appl. No.: 18/521,686

(22) Filed: Nov. 28, 2023

Related U.S. Application Data
(60) Provisional application No. 63/462,679, filed on Apr. 28, 2023.

(51) Int. Cl. G01V 1/28; G01V 1/30

(52) U.S. Cl. CPC G01V 1/282; G01V 1/30; G01V 2210/6161

(57) ABSTRACT

Described herein are systems and techniques for predicting sample characteristics in a wellbore. An example method can include determining a set of values of estimated characteristics of a sample in a wellbore; determining, via a proxy model, a predicted ultrasonic wave response corresponding to the set of values of the estimated characteristics of the sample; based on a comparison of the predicted ultrasonic wave response with a measured ultrasonic wave response associated with the sample, determining an error associated with the predicted ultrasonic wave response; determining whether the error associated with the predicted ultrasonic wave response is below a threshold; and determining whether to update the set of values of the estimated characteristics of the sample based on determining whether the error is below the threshold.

### CROSS-REFERENCE TO RELATED APPLICATIONS

This application claims the benefit of, and priority to, U.S. Provisional Application No. 63/462,679, filed on Apr. 28, 2023, and entitled “ESTIMATING MATERIAL PROPERTIES USING PROXY MODELS”, the contents of which are hereby incorporated by reference in their entirety and for all purposes.

### TECHNICAL FIELD

The present disclosure generally relates to collecting and evaluating wellbore data. For example, aspects of the present disclosure relate to systems and techniques for using proxy models to determine properties of materials in a wellbore system.

### BACKGROUND

To manage oil and gas drilling and production environments (e.g., wellbores, etc.) and perform operations in the oil and gas drilling and production environments, operators typically obtain and evaluate various types of data, such as measurements and other sensor data, to gain insights about Earth formations and conditions in a wellbore. For example, sensor data can be used to identify features within an Earth formation and other details about a wellbore and/or associated operations. However, the downhole conditions in a wellbore and associated constraints can create significant challenges in monitoring conditions downhole and deploying systems in the wellbore, such as sensors and other wellbore tools. Some example downhole conditions and constraints in a wellbore can include extreme temperatures, extreme pressures, space constraints, formation resistivity, formation conductivity, formation permeability, and complex mixtures of different elements, among others. Typically, computing resources can be used to make or facilitate various determinations and estimates used to manage a wellbore environment and/or perform wellbore operations. The computations used to make or facilitate such determinations and estimates can be resource intensive and can cause expensive delays, which can increase costs and impact wellbore operations.

### BRIEF DESCRIPTION OF THE DRAWINGS

Illustrative examples and aspects of the present application are described in detail below with reference to the following figures:

FIG. 1A is a schematic side-view of an example wireline logging environment, according to some examples of the present disclosure;

FIG. 1B is a schematic side-view of the example logging environment of FIG. 1A, according to some examples of the present disclosure;

FIG. 2A is a diagram illustrating an example process for predicting characteristics of a sample, according to some examples of the present disclosure;

FIG. 2B is a diagram illustrating another example process for using a proxy model to predict characteristics of a sample, according to some examples of the present disclosure;

FIG. 3 illustrates charts depicting an example mapping of characteristics of a material to an ultrasonic wave response, according to some examples of the present disclosure;

FIG. 4 is a diagram illustrating an example architecture of a proxy model, according to some examples of the present disclosure;

FIG. 5 is a diagram illustrating an example U-Net network that can implement the proxy model, according to some examples of the present disclosure;

FIG. 6 is a diagram illustrating an example architecture of a principal component analysis artificial neural network that can be implemented by a proxy model, according to some examples of the present disclosure;

FIG. 7 is a diagram illustrating an example physics-informed neural architecture that can be used as a proxy model, according to some examples of the present disclosure;

FIG. 8 illustrates an example prediction generated by a proxy model for a borehole with a cemented casing, according to some examples of the present disclosure;

FIG. 9 illustrates an example validation result of an ultrasonic waveform predicted by a Fourier Neural Operator or Network in a generalized case hole model, according to some examples of the present disclosure;

FIG. 10 is a flowchart illustrating an example process for predicting characteristics of a sample, according to some examples of the present disclosure; and

FIG. 11 illustrates an example computing device and hardware that can be used to implement some aspects of the disclosed technology.

### DETAILED DESCRIPTION

Various aspects and examples of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one embodiment or an embodiment, one aspect or an aspect, or one example or an example in the present disclosure can refer to the same embodiment/example/aspect/etc., or any embodiment/example/aspect/etc., and such references mean at least one of the embodiments, examples, and/or aspects.

Moreover, reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Also, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, techniques, systems, apparatuses, methods (also referred to as processes herein), non-transitory computer-readable media, and their related results according to the examples and aspects of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As previously explained, measurements and other sensor data collected in a wellbore can be used to gain insights into Earth formations and conditions in the wellbore. For example, sensor data can be used to identify features within an Earth formation and other details about a wellbore and/or associated operations. In some cases, the data can be used to measure and/or estimate information about materials, elements, surfaces, mixtures, substances, targets, and/or other samples in a downhole environment. For example, ultrasonic pulse echo using ultrasonic sensor devices can be used to test, scan, and/or measure properties of materials, elements, surfaces, mixtures, substances, and/or other samples in a downhole environment. The ultrasonic sensor devices can use ultrasonic waves to find defects/anomalies in a sample or material, measure attributes or properties (e.g., a geometry, a density, a porosity, a velocity of sound waves through a material or primary wave (P wave) velocity, an impedance, a state, viscosity, composition, physical property, etc.) of a sample or material, and/or obtain other information about a sample or material. For example, ultrasonic pulse echo can be used to estimate a geometry and/or properties of a borehole system, material, and/or sample.

Ultrasonic pulse echo can be used to estimate and/or evaluate various properties, materials, conditions, and/or characteristics of a sample(s) (e.g., systems, surfaces, matter, particles, substances, mixtures, components, elements, environments, regions, formations, etc.) in an open-hole wellbore environment, a cased-hole wellbore environment, and/or any other wellbore environment. For example, in open-hole wellbore environments, ultrasonic pulse echo can be used to estimate and/or evaluate rock formations and fluid saturation, among other things, and in cased-hole wellbore environments, ultrasonic pulse echo can be used to estimate and/or evaluate the characteristics (e.g., a thickness, a geometry, a material property, etc.) of a casing and characteristics (e.g., an elastic property, a geometry, a material property, cement bonding conditions, etc.) of an annular medium.

However, in many cases, it can be difficult to map an ultrasonic wave response obtained in an ultrasonic pulse echo implementation to specific properties, materials, conditions, and/or characteristics of a sample(s) in a wellbore environment. This can be due to various conditions, constraints, environmental factors, and/or other factors in the wellbore environment. For example, the ultrasonic wave response obtained in an ultrasonic pulse echo implementation can be difficult to map to specific material properties of a material in the wellbore environment due to various environmental and other factors such as, for example, eccentering of a tool in the borehole, variations in mud properties, and/or a multi-layer medium associated with the ultrasonic wave response, among other factors.

In some cases, physics-based numerical simulations, such as three-dimensional (3D) numerical simulations, can be used to create forward modeling predictions of an ultrasonic wave response in a specific environment. However, the physics-based numerical simulations can be very costly, time consuming and/or inefficient, and difficult to perform. Moreover, in many cases, many modeled waveforms may be needed to achieve an accurate inversion result for material properties based on physics-based numerical simulations, which can increase the time, cost, inefficiency, and/or difficulty of such physics-based numerical simulations.

Described herein are systems, apparatuses, processes (also referred to as methods), and computer-readable media (collectively referred to as “systems and techniques”) for monitoring and evaluating conditions, materials, properties, geometries, and/or samples in a wellbore environment. In some examples, the systems and techniques described herein can use a proxy model (or surrogate model) to determine properties and/or characteristics of a sample, such as a material(s) and/or system, in a wellbore environment. For example, the systems and techniques described herein can use a proxy model to determine material properties of one or more materials in a wellbore environment, a geometry of a sample such as a material or system in the wellbore environment, and/or other characteristics of a wellbore system. In some aspects, the proxy model can include a machine learning (ML) or artificial intelligence AI) model(s) such as, for example and without limitation, a fourier neural operator (FNO), a fourier neural network (FNN), a factorized FNO or FNN, a U-Net model, a principal component analysis (PCA) artificial neural network (ANN), a physics-informed neural operator (PINO), a physics-informed neural network (PINN), an AI/ML model configured to extract a global feature (e.g., an AI/ML model with a global kernel, a long-range neuron, a long-range feature and/or dependency, etc.), an AI/ML model configured to map a materials function to a wave function, and/or an AI/ML model configured to map materials properties to a waveform, among others.

In some cases, the systems and techniques described herein can implement a proxy ML/AI model to map one or more properties (e.g., geometry, density, porosity, permeability, composition, impedance, P-wave velocity, temperature, fluid saturation, rock formation, elastic property, strain, bonding, anomalies or defects, material thickness, material strength, material uniformity, compressive strength, particle size, etc.) of a sample(s) to a characteristic(s) (e.g., amplitude, phase and/or phase shift, wavelength, frequency, velocity, time-of-flight, etc.) and/or waveform of an ultrasonic wave response received from the sample(s) via ultrasonic pulse echo. In some aspects, the mapped information can be used to determine and/or evaluate a sample in a wellbore environment. For example, the mapped information can be used to determine a geometry of sample, a material of a sample, a type of sample, a composition of a sample, a defect in a sample, a thickness of a sample, a density of a sample, an identify of a sample, a porosity of a sample, a fluid saturation of a sample, etc.

In some examples, the systems and techniques described herein can train a proxy AI/ML model to predict an ultrasonic wave response for a given set of material properties, dimension attributes, and/or other characteristics of a sample(s) in a wellbore (or borehole). In some cases, the ultrasonic wave response can be used as a quick proxy for inversion of the properties of a material of interest from a waveform (e.g., the ultrasonic wave response) acquired on the field (e.g., in the wellbore). In some aspects, an inversion workflow of the systems and techniques described herein can implement a proxy AI/ML model and can replace a traditional partial differential equation (PDE) numerical solution to provide an inverted approach for estimating or predicting material properties of a sample(s) in a wellbore/borehole.

The systems and techniques described herein and associated workflows can create forward modeling predictions of an ultrasonic wave response and/or mapping of an ultrasonic wave response to sample properties/attributes in a more efficient, less costly, and less time-consuming manner than traditional PDE and/or physics-based numerical approaches. The systems and techniques described herein and associated workflows can provide accurate predictions without onerous training constraints and/or requirements. For example, in some cases, the systems and techniques described herein can enable a faster workflow (e.g., than traditional PDE and/or physics-based numerical approaches) for providing sample properties and/or attributes from raw ultrasonic pulse echo measurements, and can reduce the time needed or utilized for offline postprocessing of associated data.

As previously explained, the systems and techniques described herein can use a proxy model, such as an AI/ML proxy model, to map a material (and/or associated properties, attributes, characteristics, etc.) to an ultrasonic wave response associated with such material. Traditional PDE or physics-based numerical simulation approaches for predicting an ultrasonic wave response are generally slow due to the cumbersome computational time of traditional PDE or physics-based numerical simulation approaches such as finite element methods (FEMs), finite difference methods (FDMs), or finite volume methods (FVMs), for example. Thus, in traditional PDE or physics-based numerical simulation approaches, case coverage may be limited and new simulations may be needed for each time that a physical response prediction is needed or desired for a newly-given material. In addition, such limitations can pose significant challenges when a real-time and/or on-the-field answer is desired for an acquired waveform. On the other hand, the AI/ML models used by the systems and techniques described herein can be accurate and faster, can have a broader case coverage, and can provide real-time and on-the-field predictions from an acquired waveform (e.g., can be used to obtain a real-time inversion from well site measurements).

The systems and techniques described herein can train the AI/ML model (e.g., the proxy model) to predict the ultrasonic wave response of a material. In some examples, the input to the AI/ML model can include one or more material properties, such as a density, an elasticity, and/or an attenuation, among others, and the output of the AI/ML model can include a corresponding ultrasonic wave response, such as an amplitude and/or a phase of a reflected, scattered, and/or transmitted wave. In some aspects, the AI/ML model can implement a supervised learning approach where the model is trained on a dataset of material properties and corresponding ultrasonic wave responses.

The dataset can include a ground truth dataset and/or a dataset obtained by conducting experiments on various materials and measuring their ultrasonic wave responses using one or more sensors and equipment, and/or solving numerical solutions on various materials. Once trained, the AI/ML model can generate predictions faster than other approaches, such as traditional PDE or physics-based numerical solution approaches. Thus, the dataset can be used to train the AI/ML model, which can then be used to predict the ultrasonic wave response of a material based on one or more properties of the material.

In some examples, a proxy AI/ML model can be trained to associate a borehole material and/or associated dimension attributes to one or more ultrasonic wave responses. An illustrative example of a proxy AI/ML model that can be implemented to associated a borehole material and/or associated dimension attributes to one or more ultrasonic wave responses includes a fourier neural operator (FNO) or a fourier neural network (FNN). The FNO or FNN can replace a traditional PDE or physics-based numerical simulation system. The FNO or FNN can have a global kernel and/or long-range neurons, which can be advantageous when solving PDE problems as the change in a material can result in or necessitate long range broadcasting in the ultrasonic wave response. In other words, a change in a material can have a global impact on the ultrasonic wave response and/or the problem can have long range dependencies. Thus, the FNO or FNN may be more suitable for mapping material properties and/or associated dimension attributes to an ultrasonic wave response than a network with a local kernel and/or local window (e.g., and thus short-range neurons) such as unmodified convolutional neural networks (CNNs). In some examples, an FNO or FNN can design an associated kernel in a frequency domain.

Another illustrative example of a proxy AI/ML model that can be implemented to associated a borehole material and/or associated dimension attributes to one or more ultrasonic wave responses includes a U-Net network. The U-Net network can include or represent a modified CNN. The U-Net network can use a multi-scale kernel to capture a long-range feature (e.g., a feature with global and/or longer-range dependencies). Yet another illustrative example of a proxy AI/ML model that can be implemented to associated a borehole material and/or associated dimension attributes to one or more ultrasonic wave responses includes a PCA-ANN. A PCA-ANN can decompose a material and ultrasonic wave response into PCA components and coefficients, and map the material PCA coefficients to ultrasonic wave response PCA coefficients. Although the kernel of the PCA-ANN may include a local window, the local window is in the PCA components domain. In the original domain, it is a long-range window.

Yet another illustrative example of a proxy AI/ML model that can be implemented to associated a borehole material and/or associated dimension attributes to one or more ultrasonic wave responses includes a physics-informed neural network (PINN) or physics-informed neural operator (PINO). A PINN or PINO can use a PDE equation to train the network or operator model with or without using ground truth data. This approach can reduce the training data preparation time and cost. Other examples can include other AI/ML methods that use a long-range window kernel to achieve desired results.

An example AI/ML model with long-range neurons and/or long-range windows/kernels, as previously described, can transform a material into a target domain (e.g., a waveform domain), and can be trained in the target domain. Mathematical knowledge shows that a short-range point-wise value in a transformed domain (e.g., the waveform domain) can stand for a whole range in the original domain (e.g., material domain). Thus, the kernel of the AI/ML model has a long-range in the original domain.

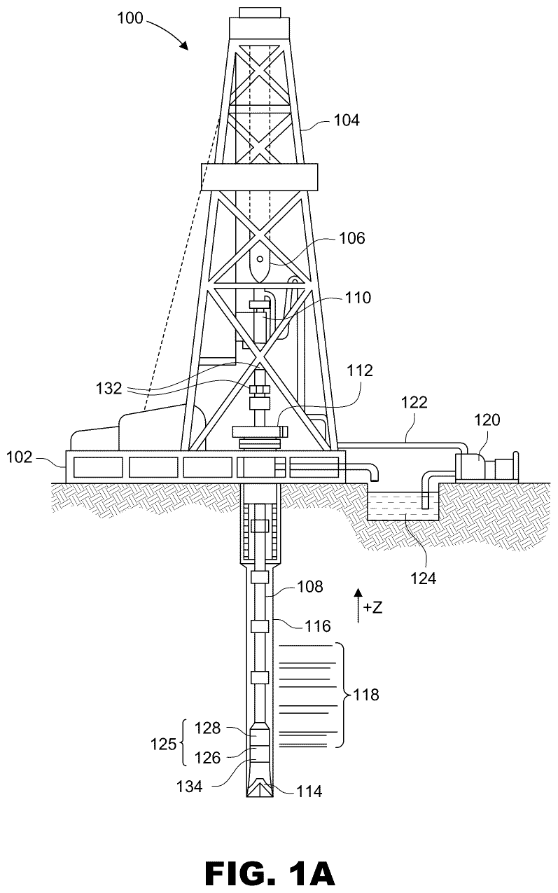

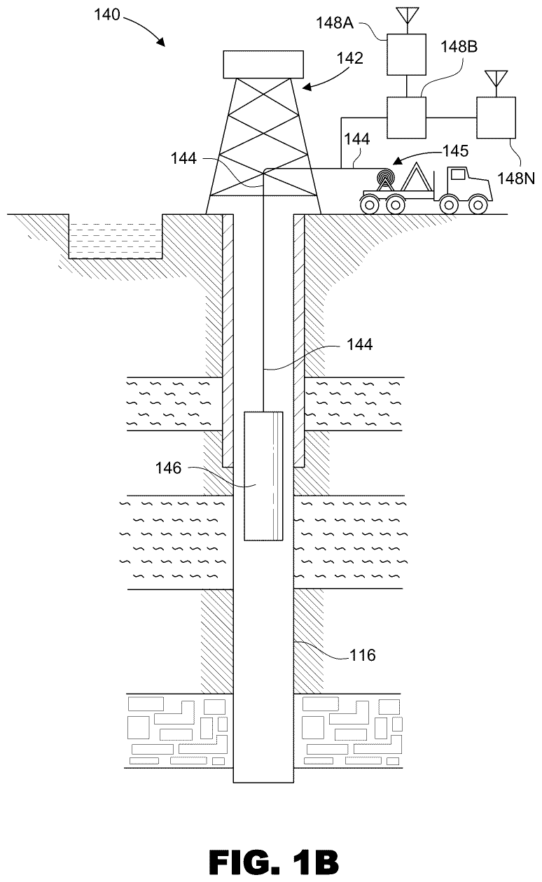

Examples of the systems and techniques described herein are illustrated in FIG. 1A through FIG. 11 and described below.

FIG. 1A is a schematic diagram of an example logging while drilling wellbore operating environment, according to some examples of the present disclosure. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an electromagnetic imager tool (not shown) as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, according to some examples of the present disclosure. In this example, an example system 140 is depicted for conducting downhole measurements after at least a portion of a wellbore has been drilled and the drill string removed from the well. An electromagnetic imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via the wireline conveyance 144 to meet power requirements of the tool. For slickline or coiled tubing configurations, power can be supplied downhole with a battery or via a downhole generator.

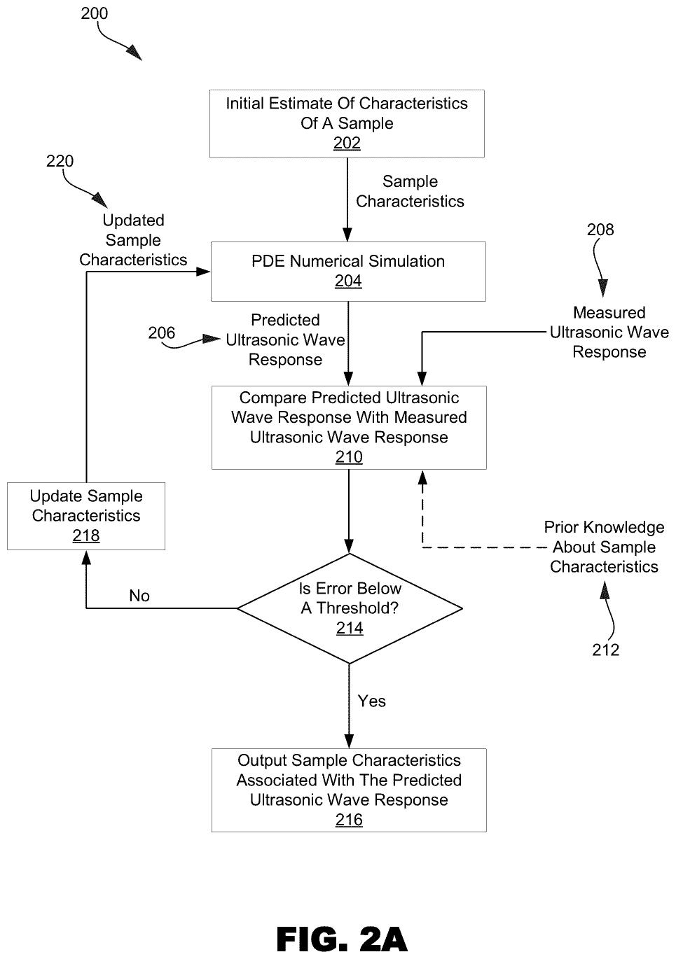

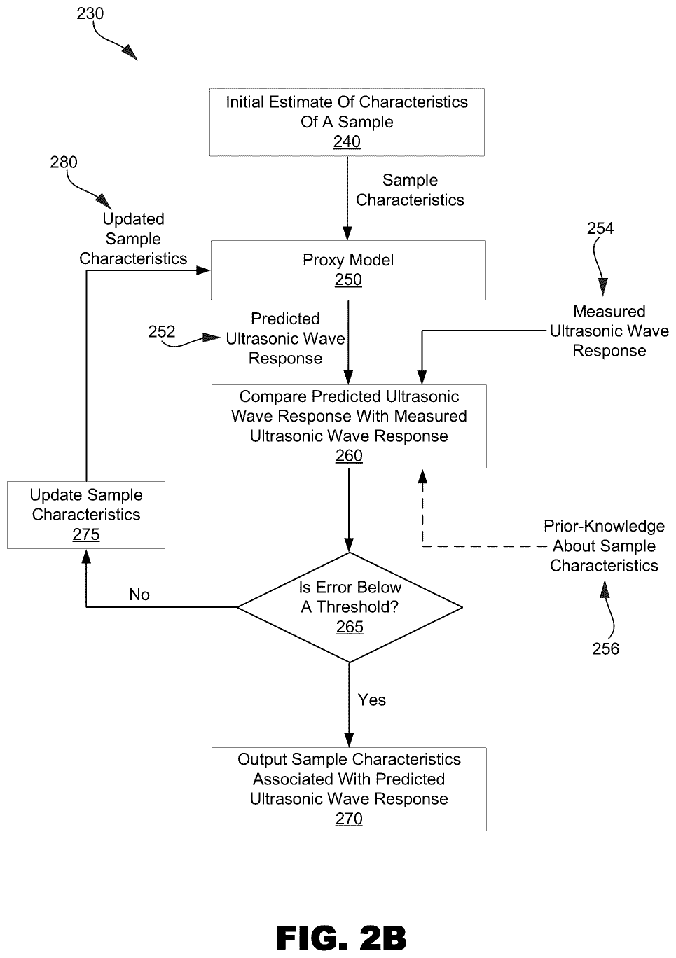

FIG. 2A is a diagram illustrating an example process 200 for predicting characteristics of a sample, such as a geometry, material properties, etc. The example process 200 in FIG. 2A uses a PDE numerical simulation method such as, for example, FEM, FDM, FVM, etc. At block 202, the process 200 can include determining an initial estimate of characteristics of a sample in a wellbore environment. The characteristics can include a geometry of the sample, material properties of the sample (e.g., density, material thickness, elasticity, composition, state, viscosity, mixture, physical property, constituents, type of material, etc.), sample features (e.g., defects/anomalies, bonding, etc.), etc.

In some cases, the initial estimate of characteristics can include an initial guess of sample characteristics (e.g., guessed geometry, guessed material properties, etc.). The initial guess can be determined based on information about the sample (e.g., type of sample, location of sample, identity of sample, etc.), sensor data, information about a wellbore associated with the sample, information about an environment in a wellbore associated with the sample, one or more candidate samples or types of samples, etc. In some cases, the initial estimate of characteristics can be generated using a model, algorithm, and/or function. For example, the initial estimate of characteristics can be generated using a model and information provided to the model such as, for example, sensor data, information about a wellbore associated with the sample, information about an environment associated with the sample, information about the sample, one or more candidate samples, etc. As further described herein, the initial estimate of characteristics of the sample can be used to generate an ultrasonic wave response associated with the initial estimate of characteristics of the sample, which can then be compared with the actual, measured ultrasonic wave response obtained for the sample to determine whether the initial estimate of characteristics is accurate or needs to be modified to identify the correct characteristics of the sample.

At block 204, the process 200 receives the initial estimate of characteristics of the sample and performs a PDE numerical simulation to generate a predicted ultrasonic wave response 206. The predicted ultrasonic wave response 206 can correspond to the initial estimate of characteristics of the sample, and can be generated using PDE numerical simulation. In other words, the predicted ultrasonic wave response 206 can include or describe the waveform and/or wave characteristics that would be obtained/produced from the sample using ultrasonic pulse echo. For example, the predicted ultrasonic wave response 206 can include the estimated physical wave response predicted to occur when testing the sample using ultrasonic pulse echo (e.g., predicted to be received from the sample).

At block 210, the process 200 can compare the predicted ultrasonic wave response 206 with a measured ultrasonic wave response 208 associated with the sample. The measured ultrasonic wave response 208 can include the ultrasonic wave response measured or received when testing the sample using ultrasonic pulse echo. Thus, the measured ultrasonic wave response 208 can represent the actual physical response measured for the sample, and can correspond to the actual characteristics of the sample. In some examples, the process 200 can include testing the sample using ultrasonic pulse echo, and obtaining the measured ultrasonic wave response 208 based on the test of the sample using ultrasonic pulse echo.

By comparing the predicted ultrasonic wave response 206 with the measured ultrasonic wave response 208, the process 200 can determine whether the initial estimate of characteristics of the sample are accurate or need to be modified. This is because the predicted ultrasonic wave response 206 corresponds to the initial estimate of characteristics of the sample, and the measured ultrasonic wave response 208 corresponds to the actual characteristics of the sample. Thus, if the predicted ultrasonic wave response 206 matches the measured ultrasonic wave response 208 (or has less than a threshold error based on the measured ultrasonic wave response 208), it means that the initial estimate of characteristics of the sample matches the actual characteristics of the sample corresponding to the actual, measured ultrasonic wave response 208.

In some cases, when comparing the predicted ultrasonic wave response 206 with the measured ultrasonic wave response 208 associated with the sample, the process 200 can also use and/or receive prior knowledge 212 about sample characteristics. The process 200 can use the prior knowledge 212 when comparing the predicted ultrasonic wave response 206 with the measured ultrasonic wave response 208 to determine whether the predicted ultrasonic wave response 206 is accurate and/or has less than a threshold error. In some cases, the prior knowledge 212 can include one or more characteristics and/or features of a physical response (e.g., an ultrasonic wave response) associated with one or more samples and/or one or more characteristics associated with one or more samples. For example, the prior knowledge 212 can include information about ultrasonic wave responses (and/or associated waveforms) corresponding to one or more samples tested using ultrasonic pulse echo. In some examples, the prior knowledge 212 can include ground truth information about ultrasonic wave responses associated with one or more samples.

The process 200 can use the prior knowledge 212 to determine an error associated with the predicted ultrasonic wave response 206, identify sample characteristics that have a corresponding or ground truth ultrasonic wave response that better matches the measured ultrasonic wave response 208 (e.g., and thus determine more accurate sample characteristics that can be used to modify the initial estimate of characteristics of the sample), and/or identify a measured or ground truth ultrasonic wave response that better matches the predicted ultrasonic wave response 206 and/or the measured ultrasonic wave response 208. For example, the process 200 can use the prior knowledge 212 to determine how to modify the sample characteristics used to generate the predicted ultrasonic wave response 206 to reduce an error generated or determined when comparing the predicted ultrasonic wave response 206 with the measured ultrasonic wave response 208. To illustrate, if the prior knowledge 212 includes one or more ultrasonic wave responses mapped to one or more sample characteristics, the process 200 can determine that the one or more sample characteristics mapped to a specific ultrasonic wave response in the prior knowledge 212 are more accurate than the initial estimate of characteristics of the sample if the specific ultrasonic wave response in the prior knowledge 212 better matches the measured ultrasonic wave response 208.

At block 214, the process 200 can determine whether an error associated with the predicted ultrasonic wave response 206 is below a threshold (and/or satisfies or matches the threshold). The process 200 can determine the error (and/or whether there is an error) associated with the predicted ultrasonic wave response 206 based on the comparison of the predicted ultrasonic wave response 206 and the measured ultrasonic wave response 208. In some cases, the error can depend on any differences (if any) between the predicted ultrasonic wave response 206 and the measured ultrasonic wave response 208. For example, if the predicted ultrasonic wave response 206 and the measured ultrasonic wave response 208 are an exact match, the error may be zero (e.g., there is no error) and thus the process 200 can determine that the error (e.g., zero error) is below the threshold. If there is not an exact match between the predicted ultrasonic wave response 206 and the measured ultrasonic wave response 208, the error can be based on the difference(s) between the predicted ultrasonic wave response 206 and the measured ultrasonic wave response 208.

In some examples, if there is a difference between the predicted ultrasonic wave response 206 and the measured ultrasonic wave response 208, the error can increase or decrease based on the type of difference(s) between the predicted ultrasonic wave response 206 and the measured ultrasonic wave response 208 (e.g., based on how they differ and/or what aspects or features of the predicted ultrasonic wave response 206 and the measured ultrasonic wave response 208 differ), the magnitude of a difference(s) between the predicted ultrasonic wave response 206 and the measured ultrasonic wave response 208, the implication of any differences between the predicted ultrasonic wave response 206 and the measured ultrasonic wave response 208 (e.g., how the error may affect the precision or accuracy of the sample characteristics corresponding to the predicted ultrasonic wave response 206, how the error may affect any differences (and/or associated error) between the sample characteristics corresponding to the predicted ultrasonic wave response 206 and the sample characteristics corresponding to the measured ultrasonic wave response 208, etc.), the error value, the desired accuracy or precision, the variability of sample characteristics associated with error values and/or changes/variations in error values, etc.

For example, if the predicted ultrasonic wave response 206 and the measured ultrasonic wave response 208 do not match (e.g., if the process 200 identifies one or more differences between the predicted ultrasonic wave response 206 and the measured ultrasonic wave response 208), the error associated with the predicted ultrasonic wave response 206 can increase as the difference between the predicted ultrasonic wave response 206 and the measured ultrasonic wave response 208 increases. On the other hand, the error associated with the predicted ultrasonic wave response 206 can decrease as the difference between the predicted ultrasonic wave response 206 and the measured ultrasonic wave response 208 decreases. As another example, the error associated with the predicted ultrasonic wave response 206 can increase or decrease depending on how the difference(s) between the predicted ultrasonic wave response 206 and the measured ultrasonic wave response 208 affects the accuracy of the sample characteristics associated with the predicted ultrasonic wave response 206 (e.g., depending on the variability between the sample characteristics corresponding to the predicted ultrasonic wave response 206 and the sample characteristics corresponding to the measured ultrasonic wave response 208 caused by the difference(s) between the predicted ultrasonic wave response 206 and the measured ultrasonic wave response 208).

To illustrate, the difference(s) between the predicted ultrasonic wave response 206 and the measured ultrasonic wave response 208 can cause a difference(s) between the sample characteristics corresponding to the predicted ultrasonic wave response 206 and the sample characteristics corresponding to the measured ultrasonic wave response 208. As the difference(s) between the sample characteristics corresponding to the predicted ultrasonic wave response 206 and the sample characteristics corresponding to the measured ultrasonic wave response 208 increases (and/or the error associated with the difference(s) between the sample characteristics corresponding to the predicted ultrasonic wave response 206 and the sample characteristics corresponding to the measured ultrasonic wave response 208), the error determined for the predicted ultrasonic wave response 206 can increase. As the difference(s) between the sample characteristics corresponding to the predicted ultrasonic wave response 206 and the sample characteristics corresponding to the measured ultrasonic wave response 208 decreases (and/or the error associated with the difference(s) between the sample characteristics corresponding to the predicted ultrasonic wave response 206 and the sample characteristics corresponding to the measured ultrasonic wave response 208), the error determined for the predicted ultrasonic wave response 206 can decrease.

As another example, the error determined for the predicted ultrasonic wave response 206 can increase or decrease depending on the type and/or magnitude of a difference(s) between the sample characteristics corresponding to the predicted ultrasonic wave response 206 and the sample characteristics corresponding to the measured ultrasonic wave response 208 as a result of any differences between the predicted ultrasonic wave response 206 and the measured ultrasonic wave response 208, and/or depending on how the difference(s) between the predicted ultrasonic wave response 206 and the measured ultrasonic wave response 208 affects the difference(s) and/or variability of the sample characteristics corresponding to the predicted ultrasonic wave response 206 relative to the sample characteristics corresponding to the measured ultrasonic wave response 208.

To illustrate, certain types of differences and/or higher magnitudes of differences between the sample characteristics corresponding to the predicted ultrasonic wave response 206 and the sample characteristics corresponding to the measured ultrasonic wave response 208 (e.g., as a result of any differences between the predicted ultrasonic wave response 206 and the measured ultrasonic wave response 208) can have a greater overall impact on the relationship (e.g., the difference(s); the error; the similarity or dissimilarity in the physical attributes, properties, and/or behavior of a sample associated with the predicted ultrasonic wave response 206 and a sample associated with the measured ultrasonic wave response 208) between the predicted ultrasonic wave response 206 (and/or the associated sample characteristics) and the measured ultrasonic wave response 208 (and/or the associated sample characteristics) than other types of differences and/or lower magnitudes of differences between the sample characteristics corresponding to the predicted ultrasonic wave response 206 and the sample characteristics corresponding to the measured ultrasonic wave response 208. Accordingly, the error associated with the predicted ultrasonic wave response 206 can increase or decrease depending on the type of difference and/or magnitude of difference between the sample characteristics corresponding to the predicted ultrasonic wave response 206 and the sample characteristics corresponding to the measured ultrasonic wave response 208 and/or depending on the overall impact on the relationship between the predicted ultrasonic wave response 206 (and/or the associated sample characteristics) and the measured ultrasonic wave response 208 (and/or the associated sample characteristics.

In some cases, the threshold can include a fixed or predetermined threshold value used for all or a subset of predictions of sample characteristics (and/or a subset of measured and/or predicted/estimated samples. In other cases, the threshold can include a threshold value determined based on (and/or that can vary based on) the measured ultrasonic wave response 208 (and/or characteristics or features thereof); a sample (and/or sample characteristics) associated with the measured ultrasonic wave response 208; the type of characteristics being estimated based on the predicted ultrasonic wave response 206 and the measured ultrasonic wave response 208; the desired accuracy and/or precision of the sample characteristics being assessed and/or predicted by the process 200, the type of sample associated with the measured ultrasonic wave response 208; the purpose or reason for predicting the characteristics associated with the sample; how the predicted sample characteristics generated by the process 200 is used and/or will be used (e.g., any operation, action, and/or activity performed (or to be performed) at least partly based on the predicted sample characteristics generated by the process 200 and/or influenced by the predicted sample characteristics; any calculations, estimates, and/or decisions made (and/or to be made) based at least partly on the predicted sample characteristics (and/or an impact of an error associated with the predicted sample characteristics on a calculation, estimate, decision, operation, action, and/or activity done or to be done at least partly on the predicted sample characteristics); a desired (and/or maximum) error margin and/or range of error margins (e.g., a maximum error margin, an optimal error margin, an acceptable error margin for a specific context(s), etc.); a sensitivity of an error(s) between the predicted ultrasonic wave response 206 and the measured ultrasonic wave response 208; an impact of an error (and/or error differences) of the predicted ultrasonic wave response 206 (and/or the associated sample or sample characteristics) on a property and/or behavior of the sample; an impact of an error (and/or error differences) of the predicted ultrasonic wave response 206 on the difference(s) between (and/or the nature of the difference(s) between) the sample characteristics associated with the predicted ultrasonic wave response 206 and the sample characteristics associated with the measured ultrasonic wave response 208; and/or any other factor(s).

In some examples, if the error associated with the predicted ultrasonic wave response 206 is below the threshold (or is not above the threshold), the process 200 can determine that the predicted ultrasonic wave response 206 (and thus the initial estimate of characteristics of the sample used to generate the predicted ultrasonic wave response 206) is accurate (and/or has a threshold accuracy and/or a threshold probability of being accurate). On the other hand, if the error associated with the predicted ultrasonic wave response 206 is not below the threshold (or is above the threshold), the process 200 can determine that the predicted ultrasonic wave response 206 (and thus the initial estimate of characteristics of the sample used to generate the predicted ultrasonic wave response 206) is not accurate (and/or does not have a threshold accuracy and/or a threshold probability of being accurate). If the process 200 determines that the predicted ultrasonic wave response 206 is not accurate, the process 200 can try to reduce the error by determining different sample characteristics estimated to be more accurate and/or adjusting the sample characteristics used to determine the predicted ultrasonic wave response 206, which the process 200 can use to generate a new predicted ultrasonic wave response as further described herein.

In FIG. 2A, if the error associated with the predicted ultrasonic wave response 206 is below the threshold (or is not above the threshold), at block 216, the process 200 can output the sample characteristics associated with the predicted ultrasonic wave response 206 (e.g., the initial estimate of characteristics of the sample). Here, the process 200 can determine that the sample characteristics associated with the predicted ultrasonic wave response 206 are accurate characteristics of the sample (e.g., correspond to the measured ultrasonic wave response 208).

If the error associated with the predicted ultrasonic wave response 206 is not below the threshold (or is above the threshold), at block 218, the process 200 can update one or more sample characteristics from the initial estimate of characteristics of the sample. For example, in response to determining that the error associated with the predicted ultrasonic wave response 206 is not below the threshold (or is above the threshold), the process 200 can generate updated sample characteristics 220. In some examples, the process 200 can generate the updated sample characteristics 220 by adjusting or modifying one or more sample characteristics used to generate the predicted ultrasonic wave response 206 (e.g., one or more of the sample characteristics from the initial estimate of characteristics of the sample). Thus, in some examples, the updated sample characteristics 220 can be at least partly based on the initial estimate of characteristic of the sample (e.g., a modified or adjusted version of the initial estimate of the characteristics of the sample). In other examples, the updated sample characteristics 220 may be entirely different sample characteristics (e.g., different than the initial estimate of characteristics of the sample) generated in response to determining that the error is not below the threshold (or is above the threshold) and/or can include one or more new or different sample characteristics relative to the initial estimate of characteristics of the sample.

In some cases, the process 200 can generate the updated sample characteristics 220 based on the measured ultrasonic wave response 208. For example, the process 200 can estimate one or more sample characteristics that may correspond to (and/or has a likelihood/probability of corresponding to) the measured ultrasonic wave response 208. In other cases, the updated sample characteristics 220 can additionally or alternatively be determined based on one or more differences between the predicted ultrasonic wave response 206 and the measured ultrasonic wave response 208 and/or an error associated with the predicted ultrasonic wave response 206. For example, the process 200 can estimate one or more sample characteristics and/or one or more adjustments to the initial estimate of characteristics of the sample that are predicted or estimated to account for (and/or have a probability/likelihood of accounting for) the difference(s) between the predicted ultrasonic wave response 206 and the measured ultrasonic wave response 208 and/or the error associated with the predicted ultrasonic wave response 206. In yet other cases, the updated sample characteristics 220 can additionally or alternatively be determined based on an error associated with the initial estimate of characteristics of the sample (e.g., as determined based on the comparison of the predicted ultrasonic wave response 206 and the measured ultrasonic wave response 208).

In some examples, the process 200 can determine or predict the updated sample characteristics 220 using a model or algorithm. For example, the process 200 can perform a PDE numerical simulation based on the measured ultrasonic wave response 208, the initial estimate of characteristics of the sample, the error associated with the predicted ultrasonic wave response 206, the prior knowledge 212, sensor data, a new estimate or guess of characteristics of the sample, and/or any other information. In some cases, the process 200 can use the prior knowledge 212 about sample characteristics (e.g., associated with one or more samples), the sensor data, the predicted ultrasonic wave response 206, the measured ultrasonic wave response 208, and/or the error associated with the predicted ultrasonic wave response 206 (and/or a difference(s) between the predicted ultrasonic wave response 206 and the measured ultrasonic wave response 208) to estimate the updated sample characteristics 220.

For example, as previously noted, the process 200 can compare the predicted ultrasonic wave response 206 with the measured ultrasonic wave response 208. The process 200 can determine one or more differences between the waveform of the predicted ultrasonic wave response 206 and the waveform of the measured ultrasonic wave response 208, such as a difference in wave amplitude, a difference in a signal phase and/or a signal phase shift, a difference in a wave velocity and/or wavelength, and/or any other features of the waveforms. The process 200 can determine one or more adjustments to the waveform of the predicted ultrasonic wave response 206 to reduce the error of the predicted ultrasonic wave response 206 and/or the difference between the waveform of the predicted ultrasonic wave response 206 and the waveform of the measured ultrasonic wave response 208. To illustrate, if the process 200 determines a difference between an amplitude and/or frequency of the predicted ultrasonic wave response 206 and the measured ultrasonic wave response 208, the process 200 can adjust the amplitude and/or frequency of the predicted ultrasonic wave response 206 to reduce the difference in amplitude and/or frequency between the predicted ultrasonic wave response 206 and the measured ultrasonic wave response 208. The process 200 can then determine one or more sample characteristics (and/or adjustments to one or more sample characteristics) based on the waveform of the predicted ultrasonic wave response 206 with the adjustment in amplitude and/or frequency, and/or based on the adjustment to the amplitude and/or frequency of the predicted ultrasonic wave response 206.

As another example, the process 200 can determine the updated sample characteristics 220 by estimating one or more sample characteristics attributed to (and/or estimated to be the root or cause of) the difference(s) between the predicted ultrasonic wave response 206 and the measured ultrasonic wave response 208, such as the difference in amplitude and/or frequency in the previous example. In some cases, to determine the updated sample characteristics 220, the process 200 can additionally or alternatively use or modify a material function associated with the predicted ultrasonic wave response 206 and/or the initial estimate of characteristics of the sample used to generate the predicted ultrasonic wave response 206. For example, the process 200 can determine a new/different and/or adjusted material function based on the error associated with the predicted ultrasonic wave response 206 and/or the difference(s) between the predicted ultrasonic wave response 206 and the measured ultrasonic wave response 208, and use the new/different and/or adjusted material function to determine the updated sample characteristics 220.

In some examples, the process 200 can determine one or more intrinsic and/or extrinsic properties of the sample that may affect the ultrasonic wave response of the sample (e.g., and thus the difference between the predicted ultrasonic wave response 206 (and/or associated sample characteristics) and the measured ultrasonic wave response 208 (and/or associated sample characteristics)), such as a density, a material thickness, a material velocity or P-wave velocity, a bonding (e.g., cement bonding), and/or any physical property of the sample. In such examples, the process 200 can determine the updated sample characteristics 220 based at least partly on the one or more intrinsic and/or extrinsic properties of the sample that may affect the ultrasonic wave response of the sample (and/or may account for the error associated with the predicted ultrasonic wave response 206 and/or the difference between the predicted ultrasonic wave response 206 and the measured ultrasonic wave response 208).

In some aspects, when determining the updated sample characteristics 220, the process 200 can determine one or more sample characteristics (and/or an adjustment to one or more sample characteristics) estimated or predicted to reduce an error gradient associated with the predicted ultrasonic wave response 206. The error gradient and/or the one or more sample characteristics (and/or the adjustment) estimated or predicted to reduce the error gradient can be determined based on the comparison between the predicted ultrasonic wave response 206 and the measured ultrasonic wave response 208. In some cases, the error gradient and/or the one or more sample characteristics (and/or the adjustment) estimated or predicted to reduce the error gradient can additionally or alternatively be determined based on other information such as, for example, the prior knowledge 212, sensor data, the predicted ultrasonic wave response 206, the initial estimate of characteristics of the sample used to generate the predicted ultrasonic wave response 206, a material function, a model or algorithm, a knowledge base, a probability model, and/or any other information.

In some aspects, the process 200 can additionally or alternatively use sensor data to determine the updated sample characteristics 220. For example, the process 200 can use a nuclear magnetic resonance (NMR) sensor to gather measurements associated with the sample. The process 200 can use the measurements from the NMR sensor to estimate one or more properties of the sample, which the process 200 can use to determine the updated sample characteristics 220.

The updated sample characteristics 220 can include one or more dimensions of the sample, a geometry of the sample, one or more material properties of the sample (e.g., density, velocity, permeability, porosity, composition, etc.), a thickness of the sample, a condition of the sample (e.g., a defect or anomaly, a bonding, etc.), and/or other information about the sample.

Once the process 200 has generated the updated sample characteristics 220, the process 200 can return to block 204, where the process 200 can use the updated sample characteristics 220 to generate a new predicted ultrasonic wave response to test at block 210. The process 200 can use the updated sample characteristics 220 to generate a more accurate ultrasonic wave response (e.g., a predicted ultrasonic wave response that better matches and/or reflects the measured ultrasonic wave response 208) and reduce or eliminate the error associated with the new ultrasonic wave response. The process 200 can iterate through blocks 204, 210, 214, and 218 until the error calculated at block 210 is below the threshold or not above the threshold (e.g., until a predicted ultrasonic wave response generated based on updated sample characteristics 220 produces an error that is below the threshold when compared to the measured ultrasonic wave response 208).

In FIG. 2A, the process 200 implements a PDE numerical simulation approach to determine a predicted ultrasonic wave response associated with one or more sample characteristics. As previously explained, the physics-based PDE numerical simulations can be costly, time consuming and inefficient, and difficult to perform. In many cases, many modeled waveforms may be needed to achieve an accurate inversion result for material properties based on physics-based PDE numerical simulations, which can increase the time, cost, inefficiency, and/or difficulty of such physics-based numerical simulations.

The systems and techniques described herein can create forward modeling predictions of an ultrasonic wave response and/or mapping of an ultrasonic wave response to sample characteristics in a more efficient, less costly, and less time-consuming manner than traditional PDE and/or physics-based numerical approaches. The systems and techniques described herein can provide accurate predictions without onerous training constraints and/or requirements. For example, in some cases, the systems and techniques described herein can enable a faster workflow (e.g., than traditional PDE and/or physics-based numerical approaches) for providing sample characteristics from raw ultrasonic pulse echo measurements, and can reduce the time needed or utilized for offline postprocessing of associated data.

Moreover, the systems and techniques described herein can use a proxy model, such as an AI/ML proxy model, to map a sample (and/or associated characteristics) to an ultrasonic wave response associated with such sample. Traditional PDE or physics-based numerical simulation approaches for predicting an ultrasonic wave response are generally slow due to the cumbersome computational time of traditional PDE or physics-based numerical simulation approaches such as finite element methods (FEMs), finite difference methods (FDMs), or finite volume methods (FVMs), for example. Thus, in traditional PDE or physics-based numerical simulation approaches, case coverage may be limited and new simulations may be needed for each time that a physical response prediction is needed or desired for a newly-given material. In addition, such limitations can pose significant challenges when a real-time and/or on-the-field answer is desired for an acquired waveform. On the other hand, the proxy model (e.g., the AI/ML model) used by the systems and techniques described herein can be accurate and faster, can have a broader case coverage, and can provide real-time and on-the-field predictions from an acquired waveform (e.g., can be used to obtain a real-time inversion from well site measurements).

FIG. 2B is a diagram illustrating another example process 230 for predicting characteristics of a sample, such as a geometry, material properties, etc. The example process 230 in FIG. 2B uses a proxy model, such as an AI/ML proxy model, to map sample characteristics to a predicted ultrasonic wave. As shown, at block 240, the process 230 can include determining an initial estimate of characteristics of a sample (e.g., estimated sample characteristics) in a wellbore environment. The sample can include any material or combination of materials. For example, the sample can include a casing, a mixture, mud, a rock formation, a tool, a cement structure, a steel structure, and/or any other material, composition, structure, and/or target. The characteristics of the sample can include a geometry of the sample, material properties of the sample (e.g., density, velocity, material thickness, elasticity, composition, state, viscosity, mixture, physical property, constituents, type of material, etc.), sample features (e.g., defects/anomalies, bonding, etc.), etc.

In some cases, the initial estimate of characteristics of the sample (e.g., estimated sample characteristics) can include an initial guess or estimate of sample characteristics (e.g., guessed geometry, guessed material properties, etc.). The initial guess or estimate can be determined based on information about the sample (e.g., type of sample, location of sample, identity of sample, etc.), sensor data, information about a wellbore associated with the sample, information about an environment in a wellbore associated with the sample, one or more candidate samples or types of samples, etc. In some cases, the initial estimate of characteristics can be generated using a model, algorithm, and/or function. For example, the initial estimate of characteristics can be generated using a model and information provided to the model such as, for example, sensor data, information about a wellbore associated with the sample, information about an environment associated with the sample, information about the sample, one or more candidate samples, etc. As further described herein, the initial estimate of characteristics of the sample can be used to generate an ultrasonic wave response associated with the initial estimate of characteristics of the sample, which can then be compared with an actual, measured ultrasonic wave response obtained for the sample to determine whether the predicted ultrasonic wave response, and thus the initial estimate of characteristics of the sample used to generate the predicted ultrasonic wave response, is accurate or needs to be modified to identify the correct characteristics of the sample.

At block 250, the process 230 receives the initial estimate of characteristics of the sample and generates a predicted ultrasonic wave response 252 using a proxy model. The predicted ultrasonic wave response 252 can correspond to the initial estimate of characteristics of the sample, and can be generated using the proxy model. In other words, the predicted ultrasonic wave response 252 can include or describe the waveform and/or wave characteristics that would be obtained/produced from the sample using ultrasonic pulse echo. For example, the predicted ultrasonic wave response 252 can include the estimated physical wave response predicted to occur when testing the sample using ultrasonic pulse echo (e.g., predicted to be received from the sample).

The proxy model used to generate the predicted ultrasonic wave response 252 can include one or more AI/ML models configured to transform an input (e.g., the initial estimate of characteristics of the sample) from an original domain (e.g., sample characteristics) to a target domain (e.g., an ultrasonic wave response). Thus, the proxy model can map sample characteristics (e.g., the initial estimate of characteristics of the sample) to a physical wave response (e.g., the predicted ultrasonic wave response generated by the proxy model). Moreover, the proxy model can include an AI/ML model capable of extracting long-range features associated with the initial estimate of characteristics of the sample and/or the predicted ultrasonic wave response 252. To illustrate, the proxy model can include a neural network with a global kernel, long-range neurons (e.g., long-range dependencies), and/or a long-range window or kernel.

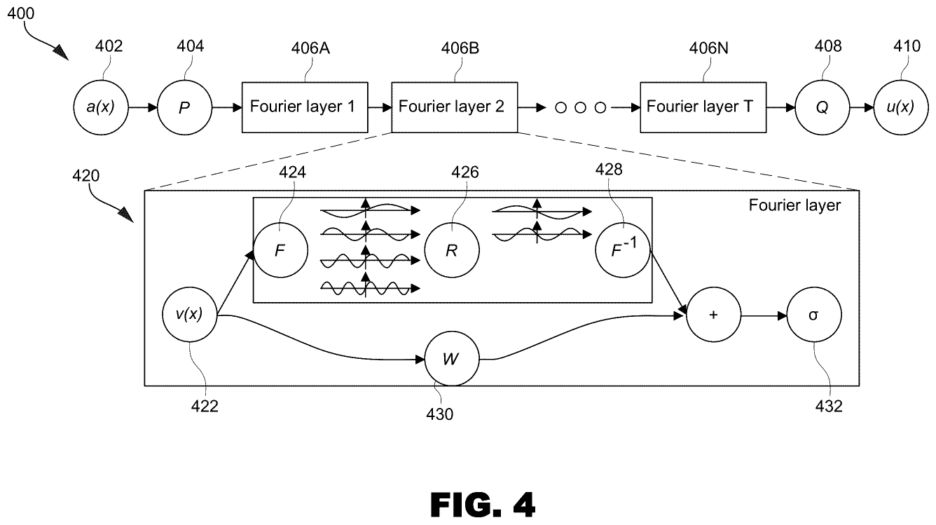

In some examples, the proxy model can include a fourier neural operator (FNO) and/or fourier neural network (FNN), as illustrated in FIG. 4, or a factorized FNO or FNN. The FNO or FNN can replace a traditional PDE or physics-based numerical simulation system. The FNO or FNN can have a global kernel and/or long-range neurons, which can be advantageous when solving PDE problems as a change in a sample characteristic (e.g., a material property) can result in or necessitate long range broadcasting in the ultrasonic wave response. In other words, a change in a sample characteristic (e.g., a material property) can have a global impact on the corresponding ultrasonic wave response and/or the problem can have long range dependencies. Thus, the FNO or FNN may be more suitable for mapping sample characteristics to an ultrasonic wave response than a network with a local kernel and/or local window (e.g., and thus short-range neurons) such as unmodified convolutional neural networks (CNNs). In some examples, an FNO or FNN can design an associated kernel in a frequency domain.

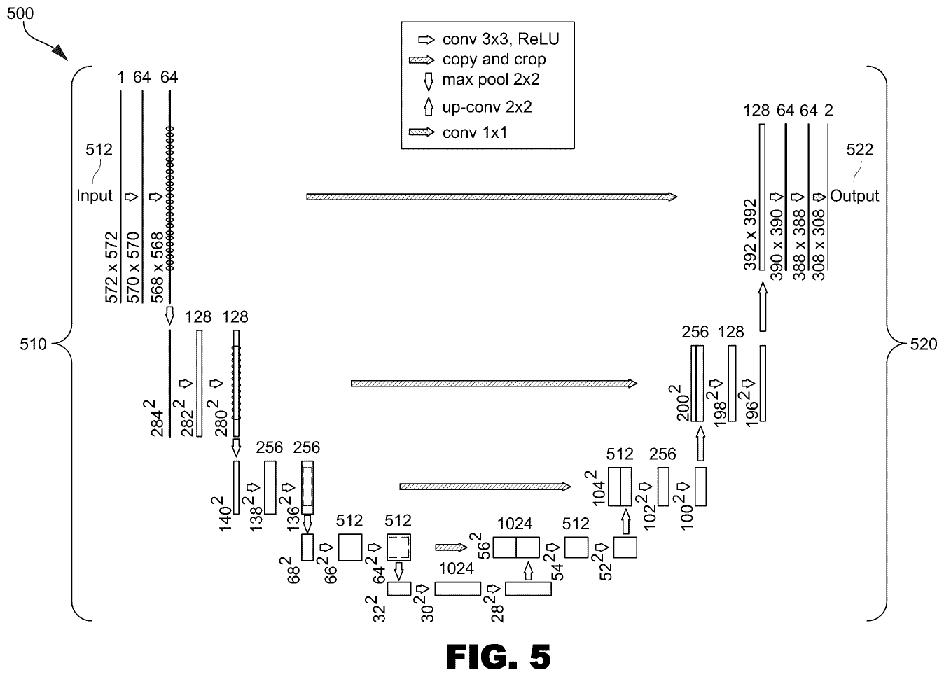

In other examples, the proxy model can include a U-Net neural network as illustrated in FIG. 5. The U-Net network can include or represent a modified CNN. The U-Net network can use a multi-scale kernel to capture a long-range feature (e.g., a feature with global and/or longer-range dependencies).

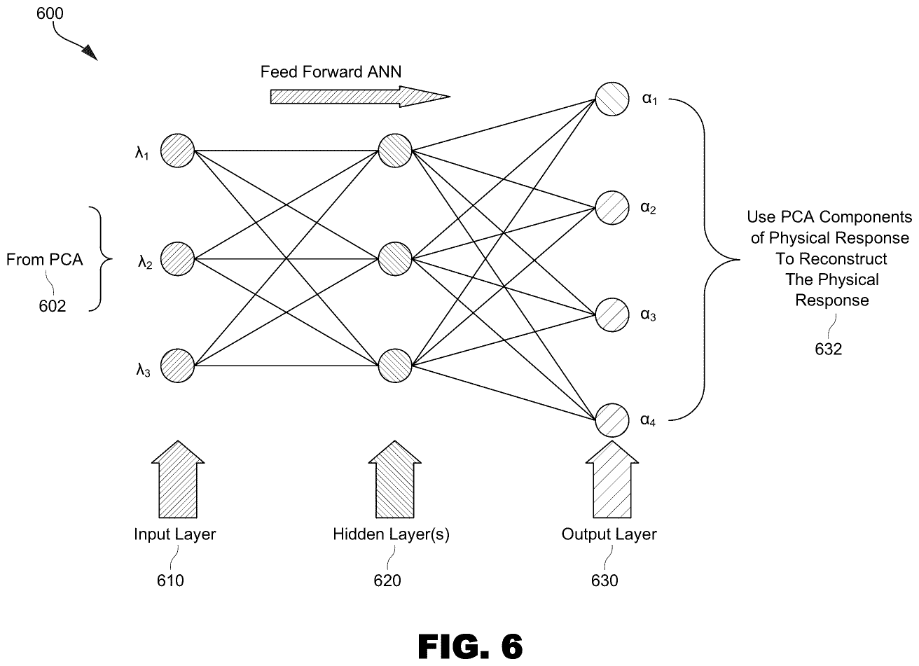

In other examples, the proxy model can include a principal component analysis (PCA) artificial neural network (ANN), as illustrated in FIG. 6. A PCA-ANN can decompose a material and associated ultrasonic wave response into PCA components and coefficients, and map the material PCA coefficients to ultrasonic wave response PCA coefficients. Although the kernel of the PCA-ANN may include a local window, the local window is in the PCA components domain. In the original domain, it is a long-range window.

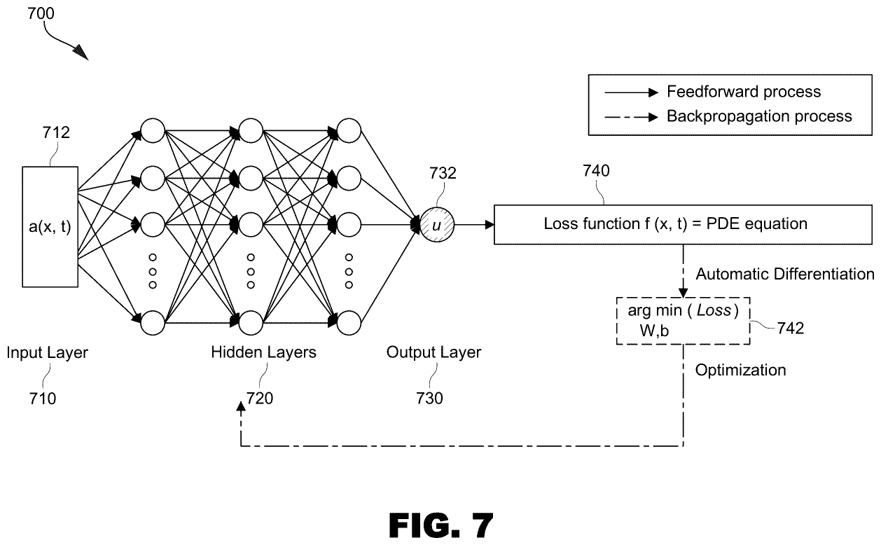

In another example, the proxy model can include a physics-informed neural network (PINN) or physics-informed neural operator (PINO), as illustrated in FIG. 7. A PINN or PINO can use a PDE equation to train the network or operator model with or without using ground truth data. This approach can reduce the training data preparation time and cost. Other examples of the proxy model can include other AI/ML methods that use a long-range window kernel to achieve desired results.

A proxy model with long-range neurons and/or long-range windows/kernels, as previously described, can transform a sample (and/or associated sample characteristics) into a target domain (e.g., a waveform domain), and can be trained in the target domain. Mathematical knowledge shows that a short-range point-wise value in a transformed domain (e.g., the waveform domain) can stand for a whole range in the original domain (e.g., material domain). Thus, the kernel of the proxy model has a long-range in the original domain.

In some aspects, the proxy model can be trained using ground truth data, such as prior-knowledge data, testing data, etc. The ground truth data can include sample characteristics and/or corresponding ultrasonic wave responses. For example, the ground truth data can include a mapping of sample characteristics to ultrasonic wave responses corresponding to the sample characteristics. As another example, the ground truth data can include ultrasonic wave responses with annotations and/or labels identifying sample characteristics corresponding to the ultrasonic wave responses.

In some aspects, the proxy model can be trained using a self-supervised (and/or similar) training scheme. For example, in some cases, the proxy model can use a PDE equation to train the proxy model with or without using ground truth data. The PDE equation can be used to determine a loss associated with an output of the proxy model, and the loss can be used to adjust the proxy model to reduce the error gradient. For example, the PDE equation can be used to determine the loss associated with the output of the proxy model, and the loss can be used to modify a material function implemented by the proxy model, a weight(s) (or bias) implemented by the proxy model, a function (e.g., an activation function, etc.) and/or operator implemented by the proxy model, and/or any other aspects of the proxy model.

At block 260, the process 230 can compare the predicted ultrasonic wave response 252 with a measured ultrasonic wave response 254 associated with the sample. The measured ultrasonic wave response 254 can include an ultrasonic wave response measured and/or acquired when testing the sample using ultrasonic pulse echo. Thus, the measured ultrasonic wave response 254 can represent the actual physical response measured for the sample using ultrasonic pulse echo, and can correspond to the actual characteristics of the sample (e.g., can include a waveform representative of the actual characteristics of the sample). In some examples, the process 230 can include testing the sample using ultrasonic pulse echo, and obtaining the measured ultrasonic wave response 254 based on the test of the sample using ultrasonic pulse echo.

By comparing the predicted ultrasonic wave response 252 with the measured ultrasonic wave response 254, the process 230 can determine whether the initial estimate of characteristics of the sample, which were used to generate the predicted ultrasonic wave response 252 and are represented by the predicted ultrasonic wave response 252, are accurate or need to be modified. This is because the predicted ultrasonic wave response 252 corresponds to the initial estimate of characteristics of the sample (e.g., the predicted ultrasonic wave response 252 is a representation of a physical response (waveform) predicted for the initial estimate of characteristics of the sample), and the measured ultrasonic wave response 254 corresponds to the actual characteristics of the sample (e.g., the measured ultrasonic wave response 254 is the actual physical response (waveform) measured/acquired for the sample). Thus, if the predicted ultrasonic wave response 252 matches the measured ultrasonic wave response 254 (or has less than a threshold error based on the measured ultrasonic wave response 254), it means that the initial estimate of characteristics of the sample, which corresponds to the predicted ultrasonic wave response 252, also matches the actual characteristics of the sample, which are represented by the measured ultrasonic wave response 254.

In some cases, when comparing the predicted ultrasonic wave response 252 with the measured ultrasonic wave response 254 associated with the sample, the process 230 can also use and/or receive prior knowledge 256 about sample characteristics. The process 230 can use the prior knowledge 256 when comparing the predicted ultrasonic wave response 252 with the measured ultrasonic wave response 254 to determine whether the predicted ultrasonic wave response 252 is accurate, determine an error associated with the predicted ultrasonic wave response 252, and/or an error of the predicted ultrasonic wave response 252 is below a threshold. In some cases, the prior knowledge 256 can include one or more characteristics and/or features of a respective physical response (e.g., a respective ultrasonic wave response) associated with a set of samples and/or characteristics associated with the set of samples. For example, the prior knowledge 256 can include information about ultrasonic wave responses, such as waveforms, corresponding to a set of samples tested using ultrasonic pulse echo. In some examples, the prior knowledge 256 can include measured/tested or ground truth information about ultrasonic wave responses associated with the set of samples.

In some cases, the process 230 can use the prior knowledge 256 to verify an error and/or assist in determine an error of the predicted ultrasonic wave response 252 when comparing the predicted ultrasonic wave response 252 with the measured ultrasonic wave response 254. Thus, the process 230 can use the prior knowledge 256 and the measured ultrasonic wave response 254 to determine an error associated with the predicted ultrasonic wave response 252. Moreover, the process 230 can additionally or alternatively use the prior knowledge 256 to identify sample characteristics that have a measured or ground truth ultrasonic wave response that better matches (e.g., has a greater similarity to and/or has a greater match with) the measured ultrasonic wave response 254. If a measured or ground truth ultrasonic wave response in the prior knowledge 256 is a better match to the measured ultrasonic wave response 254 than the predicted ultrasonic wave response 252, the process 230 can determine that the sample characteristics corresponding to that ultrasonic wave response are more accurate sample characteristics for the sample and can be used to modify the initial estimate of characteristics of the sample, as further described herein.

For example, the process 230 can use the prior knowledge 256 to determine how to modify the sample characteristics used to generate the predicted ultrasonic wave response 252 to reduce an error generated or determined when comparing the predicted ultrasonic wave response 252 with the measured ultrasonic wave response 254. To illustrate, if the prior knowledge 256 includes one or more ultrasonic wave responses mapped to one or more sample characteristics, the process 230 can determine that the one or more sample characteristics mapped to a specific ultrasonic wave response in the prior knowledge 256 are more accurate than the initial estimate of characteristics of the sample if the specific ultrasonic wave response in the prior knowledge 256 better matches the measured ultrasonic wave response 254.

As noted above, at block 260, the process 230 can determine an error associated with the predicted ultrasonic wave response 252 based on a comparison of the predicted ultrasonic wave response 252 and the measured ultrasonic wave response 254. Next, at block 265, the process 230 can determine whether an error associated with the predicted ultrasonic wave response 252 is below a threshold (and/or satisfies or matches the threshold). The process 230 can determine the error (and/or whether there is an error) associated with the predicted ultrasonic wave response 252 based on the comparison of the predicted ultrasonic wave response 252 and the measured ultrasonic wave response 254, as previously explained. The error can depend on any differences (if any) between the predicted ultrasonic wave response 252 and the measured ultrasonic wave response 254. For example, if the predicted ultrasonic wave response 252 and the measured ultrasonic wave response 254 are an exact match, the error may be zero (e.g., the predicted ultrasonic wave response 252 is correct and there is no error) and thus the process 230 can determine that the error (e.g., zero error) is below the threshold. If there is not an exact match between the predicted ultrasonic wave response 252 and the measured ultrasonic wave response 254, the mismatch can be used to determine an error of the predicted ultrasonic wave response 252. For example, the error of the predicted ultrasonic wave response 252 can be based on the difference(s) between the predicted ultrasonic wave response 252 and the measured ultrasonic wave response 254.

In some examples, if there is a difference between the predicted ultrasonic wave response 252 and the measured ultrasonic wave response 254, the error can increase or decrease based on the type of difference(s) between the predicted ultrasonic wave response 252 and the measured ultrasonic wave response 254 (e.g., based on how they differ and/or what aspects or features of the predicted ultrasonic wave response 252 and the measured ultrasonic wave response 254 differ), the magnitude of a difference(s) between the predicted ultrasonic wave response 252 and the measured ultrasonic wave response 254, the implication of any differences between the predicted ultrasonic wave response 252 and the measured ultrasonic wave response 254 (e.g., how the error may affect the precision or accuracy of the sample characteristics corresponding to the predicted ultrasonic wave response 252, how the error may affect any differences (and/or associated error) between the sample characteristics corresponding to the predicted ultrasonic wave response 252 and the sample characteristics corresponding to the measured ultrasonic wave response 254, etc.), the error value, the desired accuracy or precision, the variability of sample characteristics associated with error values and/or changes/variations in error values, weights and/or biases assigned to different types of variations between the predicted ultrasonic wave response 252 and the measured ultrasonic wave response 254 (e.g., differences in one feature, such as amplitude, may be weighed different than differences in another feature, such as a phase or frequency), etc.

For example, if the predicted ultrasonic wave response 252 and the measured ultrasonic wave response 254 do not match (e.g., if the process 230 identifies one or more differences between the predicted ultrasonic wave response 252 and the measured ultrasonic wave response 254), the error associated with the predicted ultrasonic wave response 252 can increase as the difference between the predicted ultrasonic wave response 252 and the measured ultrasonic wave response 254 increases. On the other hand, the error associated with the predicted ultrasonic wave response 252 can decrease as the difference between the predicted ultrasonic wave response 252 and the measured ultrasonic wave response 254 decreases. As another example, the error associated with the predicted ultrasonic wave response 252 can increase or decrease depending on how the difference(s) between the predicted ultrasonic wave response 252 and the measured ultrasonic wave response 254 affects the accuracy of the sample characteristics associated with the predicted ultrasonic wave response 252 (e.g., depending on the variability between the sample characteristics corresponding to the predicted ultrasonic wave response 252 and the sample characteristics corresponding to the measured ultrasonic wave response 254 caused by the difference(s) between the predicted ultrasonic wave response 252 and the measured ultrasonic wave response 254).

To illustrate, since the predicted ultrasonic wave response 252 is a representation of the initial estimate of characteristics of the sample and the measured ultrasonic wave response 254 is a representation of the actual characteristics of the sample, the difference(s) between the predicted ultrasonic wave response 252 and the measured ultrasonic wave response 254 can cause a difference(s) between the sample characteristics corresponding to the predicted ultrasonic wave response 252 and the sample characteristics corresponding to the measured ultrasonic wave response 254. As the difference(s) between the sample characteristics corresponding to the predicted ultrasonic wave response 252 and the sample characteristics corresponding to the measured ultrasonic wave response 254 increases (and/or the error associated with the difference(s) between the sample characteristics corresponding to the predicted ultrasonic wave response 252 and the sample characteristics corresponding to the measured ultrasonic wave response 254), the error determined for the predicted ultrasonic wave response 252 can increase. As the difference(s) between the sample characteristics corresponding to the predicted ultrasonic wave response 252 and the sample characteristics corresponding to the measured ultrasonic wave response 254 decreases (and/or the error associated with the difference(s) between the sample characteristics corresponding to the predicted ultrasonic wave response 252 and the sample characteristics corresponding to the measured ultrasonic wave response 254), the error determined for the predicted ultrasonic wave response 252 can decrease.

As another example, the error determined for the predicted ultrasonic wave response 252 can increase or decrease depending on the type and/or magnitude of a difference(s) between the sample characteristics corresponding to the predicted ultrasonic wave response 252 and the sample characteristics corresponding to the measured ultrasonic wave response 254 as a result of any differences between the predicted ultrasonic wave response 252 and the measured ultrasonic wave response 254, and/or depending on how the difference(s) between the predicted ultrasonic wave response 252 and the measured ultrasonic wave response 254 affects the difference(s) and/or variability of the sample characteristics corresponding to the predicted ultrasonic wave response 252 relative to the sample characteristics corresponding to the measured ultrasonic wave response 254.

To illustrate, certain types of differences and/or higher magnitudes of differences between the sample characteristics corresponding to the predicted ultrasonic wave response 252 and the sample characteristics corresponding to the measured ultrasonic wave response 254 (e.g., as a result of any differences between the predicted ultrasonic wave response 252 and the measured ultrasonic wave response 254) can have a greater overall impact on the relationship (e.g., the difference(s); the error; the similarity or dissimilarity in the physical attributes, properties, and/or behavior of a sample associated with the predicted ultrasonic wave response 252 and a sample associated with the measured ultrasonic wave response 254) between the predicted ultrasonic wave response 252 (and/or the associated sample characteristics) and the measured ultrasonic wave response 254 (and/or the associated sample characteristics) than other types of differences and/or lower magnitudes of differences between the sample characteristics corresponding to the predicted ultrasonic wave response 252 and the sample characteristics corresponding to the measured ultrasonic wave response 254. Accordingly, the error associated with the predicted ultrasonic wave response 252 can increase or decrease depending on the type of difference and/or magnitude of difference between the sample characteristics corresponding to the predicted ultrasonic wave response 252 and the sample characteristics corresponding to the measured ultrasonic wave response 254 and/or depending on the overall impact on the relationship between the predicted ultrasonic wave response 252 (and/or the associated sample characteristics) and the measured ultrasonic wave response 254 (and/or the associated sample characteristics.

In some cases, the threshold can include a fixed or predetermined threshold value used for all or a subset of predictions of sample characteristics (and/or a subset of measured and/or predicted/estimated samples. In other cases, the threshold can include a threshold value determined based on (and/or that can vary based on) the measured ultrasonic wave response 254 (and/or characteristics or features thereof); a sample (and/or sample characteristics) associated with the measured ultrasonic wave response 254; the type of characteristics being estimated based on the predicted ultrasonic wave response 252 and the measured ultrasonic wave response 254; the desired accuracy and/or precision of the sample characteristics being assessed and/or predicted by the process 230, the type of sample associated with the measured ultrasonic wave response 254; the purpose or reason for predicting the characteristics associated with the sample; how the predicted sample characteristics generated by the process 230 is used and/or will be used (e.g., any operation, action, and/or activity performed (or to be performed) at least partly based on the predicted sample characteristics generated by the process 230 and/or influenced by the predicted sample characteristics; any calculations, estimates, and/or decisions made (and/or to be made) based at least partly on the predicted sample characteristics (and/or an impact of an error associated with the predicted sample characteristics on a calculation, estimate, decision, operation, action, and/or activity done or to be done at least partly on the predicted sample characteristics); a desired (and/or maximum) error margin and/or range of error margins (e.g., a maximum error margin, an optimal error margin, an acceptable error margin for a specific context(s), etc.); a sensitivity of an error(s) between the predicted ultrasonic wave response 252 and the measured ultrasonic wave response 254; an impact of an error (and/or error differences) of the predicted ultrasonic wave response 252 (and/or the associated sample or sample characteristics) on a property and/or behavior of the sample; an impact of an error (and/or error differences) of the predicted ultrasonic wave response 252 on the difference(s) between (and/or the nature of the difference(s) between) the sample characteristics associated with the predicted ultrasonic wave response 252 and the sample characteristics associated with the measured ultrasonic wave response 254; and/or any other factor(s).

In some examples, if the error associated with the predicted ultrasonic wave response 252 is below the threshold (or is not above the threshold), the process 230 can determine that the predicted ultrasonic wave response 252 (and thus the initial estimate of characteristics of the sample used to generate the predicted ultrasonic wave response 252) is accurate (and/or has a threshold accuracy and/or a threshold probability of being accurate). On the other hand, if the error associated with the predicted ultrasonic wave response 252 is not below the threshold (or is above the threshold), the process 230 can determine that the predicted ultrasonic wave response 252 (and thus the initial estimate of characteristics of the sample used to generate the predicted ultrasonic wave response 252) is not accurate (and/or does not have a threshold accuracy and/or a threshold probability of being accurate). If the process 230 determines that the predicted ultrasonic wave response 252 is not accurate, the process 230 can try to reduce the error by determining different sample characteristics estimated to be more accurate and/or adjusting the sample characteristics used to determine the predicted ultrasonic wave response 252, which the process 230 can use to generate a new predicted ultrasonic wave response as further described herein.

In FIG. 2B, if the error associated with the predicted ultrasonic wave response 252 is below the threshold (or is not above the threshold), at block 270, the process 230 can output the sample characteristics associated with the predicted ultrasonic wave response 252 (e.g., the initial estimate of characteristics of the sample). Here, the process 230 can determine that the sample characteristics associated with the predicted ultrasonic wave response 252 are accurate characteristics of the sample.

If the error associated with the predicted ultrasonic wave response 252 is not below the threshold (or is above the threshold), at block 275, the process 230 can update one or more sample characteristics from the initial estimate of characteristics of the sample. For example, in response to determining that the error associated with the predicted ultrasonic wave response 252 is not below the threshold (or is above the threshold), the process 230 can generate updated sample characteristics 280. In some examples, the process 230 can generate the updated sample characteristics 280 by adjusting or modifying one or more sample characteristics used to generate the predicted ultrasonic wave response 252 (e.g., one or more of the sample characteristics from the initial estimate of characteristics of the sample). Thus, in some examples, the updated sample characteristics 280 can be at least partly based on the initial estimate of characteristic of the sample (e.g., a modified or adjusted version of the initial estimate of the characteristics of the sample). In other examples, the updated sample characteristics 280 may be entirely different sample characteristics (e.g., different than the initial estimate of characteristics of the sample) generated in response to determining that the error is not below the threshold (or is above the threshold) and/or can include one or more new or different sample characteristics relative to the initial estimate of characteristics of the sample.

In some cases, the process 230 can generate the updated sample characteristics 280 at least partly based on the measured ultrasonic wave response 254. For example, the process 230 can estimate one or more sample characteristics that may correspond to (and/or has a likelihood/probability of corresponding to) the measured ultrasonic wave response 254. In other cases, the updated sample characteristics 280 can additionally or alternatively be determined based on one or more differences between the predicted ultrasonic wave response 252 and the measured ultrasonic wave response 254 and/or an error associated with the predicted ultrasonic wave response 252. For example, the process 230 can estimate one or more sample characteristics and/or one or more adjustments to the initial estimate of characteristics of the sample that are predicted or estimated to account for (and/or have a probability/likelihood of accounting for) the difference(s) between the predicted ultrasonic wave response 252 and the measured ultrasonic wave response 254 and/or the error associated with the predicted ultrasonic wave response 252. In yet other cases, the updated sample characteristics 280 can additionally or alternatively be determined based on an error associated with the initial estimate of characteristics of the sample (e.g., as determined based on the comparison of the predicted ultrasonic wave response 252 and the measured ultrasonic wave response 254).

In some examples, the process 230 can determine or predict the updated sample characteristics 280 using a model or algorithm. For example, the process 230 can perform a PDE numerical simulation based on the measured ultrasonic wave response 254, the initial estimate of characteristics of the sample, the error associated with the predicted ultrasonic wave response 252, the prior knowledge 256, sensor data, a new estimate or guess of characteristics of the sample, and/or any other information. In some cases, the process 230 can use the prior knowledge 256 about sample characteristics (e.g., associated with one or more samples), the sensor data, the predicted ultrasonic wave response 252, the measured ultrasonic wave response 254, and/or the error associated with the predicted ultrasonic wave response 252 (and/or a difference(s) between the predicted ultrasonic wave response 252 and the measured ultrasonic wave response 254) to estimate the updated sample characteristics 280.

For example, as previously noted, the process 230 can compare the predicted ultrasonic wave response 252 with the measured ultrasonic wave response 254. The process 230 can determine one or more differences between the waveform of the predicted ultrasonic wave response 252 and the waveform of the measured ultrasonic wave response 254, such as a difference in wave amplitude, a difference in a signal phase and/or a signal phase shift, a difference in a wave frequency, a difference in a wavelength, and/or any other features of the waveforms. The process 230 can determine one or more adjustments to the waveform of the predicted ultrasonic wave response 252 to reduce the error of the predicted ultrasonic wave response and/or the difference between the waveform of the predicted ultrasonic wave response and the waveform of the measured ultrasonic wave response 254. To illustrate, if the process 230 determines a difference between an amplitude and/or frequency of the predicted ultrasonic wave response 252 and the measured ultrasonic wave response 254, the process 230 can adjust the amplitude and/or frequency of the predicted ultrasonic wave response 252 to reduce the difference in amplitude and/or frequency between the predicted ultrasonic wave response 252 and the measured ultrasonic wave response 254. The process 230 can then determine one or more sample characteristics (and/or adjustments to one or more sample characteristics) based on the waveform of the predicted ultrasonic wave response 252 with the adjustment in amplitude and/or frequency, and/or based on the adjustment to the amplitude and/or frequency of the predicted ultrasonic wave response 252.

As another example, the process 230 can determine the updated sample characteristics 280 by estimating one or more sample characteristics attributed to (and/or estimated to be the root or cause of) the difference(s) between the predicted ultrasonic wave response 252 and the measured ultrasonic wave response 254, such as the difference in amplitude and/or frequency in the previous example. For example, the process 230 can determine one or more sample characteristics that may result in an ultrasonic wave form with a lower error. In the previous example where the predicted ultrasonic wave response 252 and the measured ultrasonic wave response 254 have different amplitudes and/or frequencies, the process 230 can determine one or more sample characteristics that are estimated to yield an amplitude and/or frequency that matches the amplitude and/or frequency of the measured ultrasonic wave response 254 and/or has a greater similarity/match to the amplitude and/or frequency of the measured ultrasonic wave response 254. The process 230 can include such sample characteristics in the updated sample characteristics 280 used by the proxy model at block 250 to generate a new predicted ultrasonic wave, as further described herein.

In some cases, to determine the updated sample characteristics 280, the process 230 can additionally or alternatively use or modify a material function associated with the predicted ultrasonic wave response 252 and/or the initial estimate of characteristics of the sample used to generate the predicted ultrasonic wave response 252. For example, the process 230 can determine a new/different and/or adjusted material function based on the error associated with the predicted ultrasonic wave response 252 and/or the difference(s) between the predicted ultrasonic wave response 252 and the measured ultrasonic wave response 254, and use the new/different and/or adjusted material function to determine the updated sample characteristics 280.

In some aspects, the process 230 can determine one or more intrinsic and/or extrinsic properties of the sample that may affect the ultrasonic wave response of the sample (e.g., and thus the difference between the predicted ultrasonic wave response 252 (and/or associated sample characteristics) and the measured ultrasonic wave response 254 (and/or associated sample characteristics)), such as a density, a material thickness, a material velocity or P-wave velocity, a bonding (e.g., cement bonding), and/or any physical property of the sample. In such examples, the process 230 can determine the updated sample characteristics 280 based at least partly on the one or more intrinsic and/or extrinsic properties of the sample that may affect the ultrasonic wave response of the sample (and/or may account for the error associated with the predicted ultrasonic wave response 252 and/or the difference between the predicted ultrasonic wave response 252 and the measured ultrasonic wave response 254).

When determining the updated sample characteristics 280, the process 230 can determine one or more sample characteristics (and/or an adjustment to one or more sample characteristics) estimated or predicted to reduce an error gradient associated with the predicted ultrasonic wave response 252. The error gradient and/or the one or more sample characteristics (and/or the adjustment) estimated or predicted to reduce the error gradient can be determined based on the comparison between the predicted ultrasonic wave response 252 and the measured ultrasonic wave response 254. In some cases, the error gradient and/or the one or more sample characteristics (and/or the adjustment) estimated or predicted to reduce the error gradient can additionally or alternatively be determined based on other information such as, for example, the prior knowledge 256, sensor data, the predicted ultrasonic wave response 252, the initial estimate of characteristics of the sample used to generate the predicted ultrasonic wave response 252, a material function, a model or algorithm, a knowledge base, a probability model, and/or any other information.

In some aspects, the process 230 can additionally or alternatively use sensor data to determine the updated sample characteristics 280. For example, the process 230 can use an NMR sensor to gather measurements associated with the sample. The process 230 can use the measurements from the NMR sensor to estimate one or more characteristics of the sample, which the process 230 can use to determine the updated sample characteristics 280 and/or can include in the updated sample characteristics 280.

The updated sample characteristics 280 can include one or more dimensions of the sample, a geometry of the sample, one or more material properties of the sample (e.g., density, velocity, permeability, porosity, composition, etc.), a thickness of the sample, a state and/or condition of the sample (e.g., a defect or anomaly, a bonding, etc.), and/or other information about the sample. For example, the updated sample characteristics 280 can include a thickness and/or material property (e.g., density, velocity, etc.) of a casing, a material property and/or composition of a rock formation, a material property and/or composition of a mixture, a fluid saturation of a sample, etc.

Once the process 230 has generated the updated sample characteristics 280, the process 230 can return to block 250, where the process 230 can use the updated sample characteristics 280 to generate a new predicted ultrasonic wave response to test at block 260. The process 230 can input the updated sample characteristics 280 to the proxy model, which can use the updated sample characteristics 280 to generate a new ultrasonic wave response with a reduced error (e.g., a predicted ultrasonic wave response that better matches and/or reflects the measured ultrasonic wave response 254). The proxy model can aim to generate an ultrasonic wave response without an error or with a reduced error relative to the measured ultrasonic wave response 254. In some examples, the process 230 can iterate through blocks 250, 260, 265, and/or 275 until an error calculated at block 260 is below the threshold or not above the threshold (e.g., until a predicted ultrasonic wave response generated based on updated sample characteristics produces an error that is below the threshold when compared to the measured ultrasonic wave response 254).

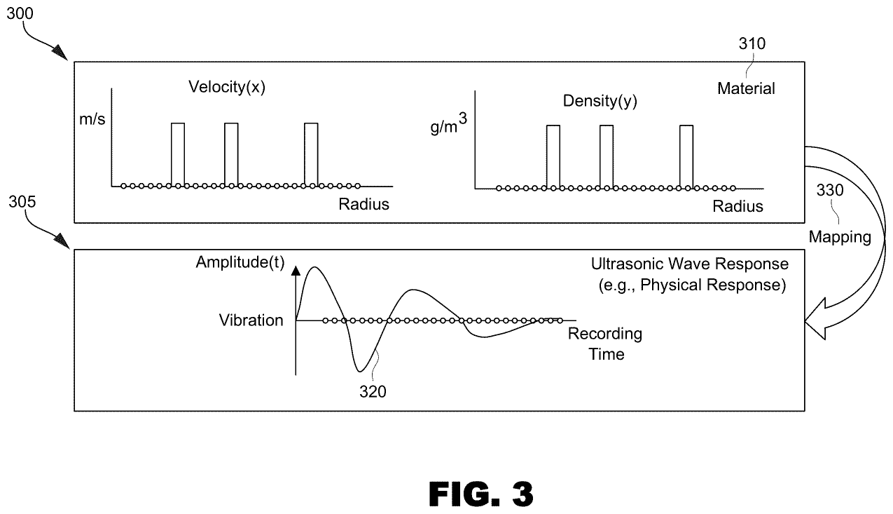

FIG. 3 illustrates charts depicting an example mapping 330 of characteristics (e.g., elastic velocity and density) of a material 310 to an ultrasonic wave response 320. In this example, the chart 300 shows a distribution of an elastic velocity of the material 310 and a density of the material 310 along a distance from an ultrasonic pulse echo source (e.g., a transmitter or transceiver in transmitting mode) and an ultrasonic pulse echo receiver, and the chart 305 provides a representation of a waveform of an ultrasonic wave response 320. The ultrasonic wave response 320 can include a waveform corresponding to the material 310, such as an amplitude, wavelength, frequency, etc.

In some cases, the mapping 330 can be used and/or generated in a training phase to train a proxy model to generate a predicted ultrasonic wave response corresponding to one or more input sample characteristics. For example, the distribution of the elastic velocity and density of the material 310 along a distance depicted in the chart 300 can represent a known or ground truth distribution of elastic velocity and density of the material 310 along a distance. The ultrasonic wave response 320 can include a waveform recorded and/or measured for the material 310 over a period of time. The distribution of the elastic velocity and density of the material 310 in the chart 300 and the ultrasonic wave response 320 can be used to train the proxy model to generate predicted ultrasonic wave responses based on sample characteristics. For example, the distribution of the elastic velocity and density of the material 310 in the chart 300 can be fed into the proxy model, which can map the distribution of the elastic velocity and density of the material 310 to the ultrasonic wave response 320. In some training examples, the proxy model can use ground truth data to determine a loss or cost when generating a predicted ultrasonic wave response (and/or a mapping of sample characteristics to an ultrasonic wave response), which the proxy model can use to update one or more aspects of the proxy model, such as one or more functions and/or weights/biases, to reduce an error gradient and learn to produce more accurate ultrasonic wave responses and/or mappings of sample characteristics to ultrasonic wave responses.

In some cases, in an inference or prediction phase, the proxy model can generate a mapping, such as the mapping 330, based on sample characteristics, such as distribution of the elastic velocity and density of the material 310 in chart 300. For example, the proxy model can receive sample characteristics as input, such as the elastic velocity and density of the material 310 in chart 300, and generate a predicted ultrasonic wave response (e.g., ultrasonic wave response 320) corresponding to and/or mapped to the input sample characteristics.

In some examples, during an inference or prediction phase, the proxy model can generate the ultrasonic wave response 320 and the mapping 330 as previously described with respect to block 250 in FIG. 2B. For example, the proxy model can transform the sample characteristics (e.g., the elastic velocity and density of the material 310 in the chart 300) from a sample characteristics distribution domain to a physical response domain (e.g., from sample characteristics to an ultrasonic wave response).

FIG. 4 is a diagram illustrating an example architecture 400 of a proxy model. The architecture 400 in this example represents an FNO, where the input includes a sample characteristics function (e.g., a material properties function) and the output includes a physical response function. However, in other examples, the architecture 400 can include an FNN where the input includes sample characteristics (e.g., sample characteristics values and/or distribution) and the output includes a physical response (e.g., a waveform and/or waveform values/details).

The FNO is an operator for a neural network and can perform convolutions applying the Fourier transform. This causes the higher modes to be removed from the Fourier space, leaving lower modes. In FIG. 4, the FNO receives an input 402 and apply a transform 404 to raise the input 402 to a higher dimension channel space. In some examples, the input 402 can include a function of sample characteristics, such as a materials function. In other examples, the architecture 400 can be used for an FNN where the input 402 includes sample characteristics or a distribution of sample characteristics. In some cases, the transform 404 can be applied with a parametric procedure and/or using a linear layer or a neural network, such as a fully connected (FC) neural network.

The FNO can then apply a number of Fourier layers 406A-406N to the output from the transform 404. The FNO can then apply another transform 408 to the output from the last layer of the Fourier layers (e.g., Fourier layer 406N). In some examples, the transform 408 can be applied locally. The transform 408 can include a neural network, such as an FC neural network. The transform 408 can project the output from the last layer of the Fourier layers (e.g., Fourier layer 406N) to the target dimension, such as a physical response dimension (e.g., a waveform dimension), to generate the output 410 of the FNO implementing the architecture 400. The output 410 can include a wave function in the case of an FNO, or a waveform and/or waveform values in the case of an FNN.

The bottom path illustrated in FIG. 4 represents an example architecture 420 of a Fourier layer 406B. In some examples, each of the Fourier layers 406A-406N can implement the example architecture 420. The architecture 420 of the Fourier layers can be used to implement a global convolution operator using a Fourier transform, a linear transform, and an inverse Fourier transform. The use of Fourier transformation can be faster and more efficient than using a PDE numerical solution. For example, the inputs and outputs of PDEs are generally continuous functions. Therefore, it is usually more efficient to represent the inputs and outputs in Fourier space.

As shown, the input 422 to the Fourier layer includes a function. The function can correspond to the result of the transform 404 projecting the input 402 to a higher dimension channel space. The Fourier layer applies a Fourier transform 424 to the input 422. A linear transform 426 is applied to the output from the Fourier transform 424 on the lower Fourier modes. The linear transform 426 can filter out the higher modes from the output from the Fourier transform 424. The Fourier layer then applies an inverse Fourier transform 428.

The output of the Fourier layer (e.g., the output of the inverse Fourier transform 428) can then be added with a bias term 430. In some examples, the bias term 430 can include a linear transformation. The Fourier layer can then apply an activation function 432 to the result of adding the output of the Fourier layer with the bias term 430.

FIG. 5 is a diagram illustrating an example U-Net network 500 that can implement the proxy model described with respect to block 250 in FIG. 2B. The U-Net network 500 can include a contracting path 510 that applies a convolutional process on an input 512, and an expansive path 520 that uses transposed 2d convolutional layers to generate an output 522. The U-Net network 500 can use a multi-scale kernel to capture long-range features when mapping sample characteristics to a predicted ultrasonic wave response.

The contracting path 510 can follow an architecture of a convolutional network. For example, the contracting path 510 can include a repeated application of two 3×3 convolutions (e.g., unpadded convolutions), each followed by a rectified linear unit (ReLU) and a 2×2 max pooling operation with stride 2 for downsampling. At each downsampling step, the number of feature channels can be increased (e.g., doubled). Every step in the expansive path 520 can include an upsampling of the feature map followed by a 2×2 convolution (“up-convolution”) that halves the number of feature channels, a concatenation with the cropped feature map from the contracting path 510, and two 3×3 convolutions followed by a ReLU. The cropping can be performed due to the loss of border pixels in every convolution. At the final layer, a 1×1 convolution can be used to map each 64-component feature vector to the desired number of classes.

FIG. 6 is a diagram illustrating an example architecture of a PCA-ANN network 600 that can be implemented by a proxy model. For example, the PCA-ANN network 600 can be used to implement the proxy model described with respect to block 250 illustrated in FIG. 2B.

The PCA-ANN 600 can decompose a sample and associated ultrasonic wave response into PCA components and coefficients, and map the sample PCA coefficients 602 to ultrasonic wave response PCA coefficients 632. Although the kernel of the PCA-ANN 600 may include a local window, the local window is in the PCA components domain so, in the original domain, it is a long-range window.

The PCA-ANN 600 can include an input layer 610 to process the sample PCA coefficients 602. The hidden layers 620 of the PCA-ANN 600 can process the output from the input layer 610, and the output layer 630 can use the outputs from the hidden layers 620 to generate the ultrasonic wave response PCA coefficients 632. The ultrasonic wave response PCA coefficients 632 can be used to reconstruct an ultrasonic wave response corresponding to sample characteristics associated with the sample PCA coefficients 602.

FIG. 7 is a diagram illustrating an example physics-informed neural architecture 700 of a PINN/PINNO that can be used as a proxy model as described with respect to block 250 in FIG. 2B. The architecture 700 can include a neural network architecture such as, for example and without limitation, an FC neural network, a U-Net neural network, a PCA-ANN, etc.

The architecture 700 can include an input layer 712, hidden layers 720, and an output layer 730. The input layer 712 can receive an input 712, such as an input distribution of sample characteristics, an input vector of sample characteristics, input values associated with a material, a material function, etc., and the output layer 730 can generate a prediction 732. The prediction 732 can include a predicted ultrasonic wave response corresponding to the input 712.

During a training phase, the architecture 700 can also include a loss function 740 used to calculate a loss 742 based on the prediction 732 generated by the output layer 730. In some examples, a PDE equation can be used as the loss function 740 to calculate the loss 742, as the PDE equation can map, identify, and/or extract the relationship between a physical response (e.g., the prediction 732) and sample characteristics (e.g., the input 712). In some cases, the PDE equation can be used to train the PINN/PINNO with or without using training data, such as ground truth data. For example, the PDE equation can be used to train the PINN/PINNO using a self-supervising scheme without ground truth data. By relying on the loss function 740 (e.g., the PDE equation) to train the network without ground truth data, the time otherwise used to prepare training data can be reduced or eliminated.

The loss 742 can be fed back into the network, which can use the loss 742 to reduce the error gradient associated with the prediction. For example, the network can use the loss 742 to adjust one or more coefficients, weights/biases, and/or functions implemented by the network.

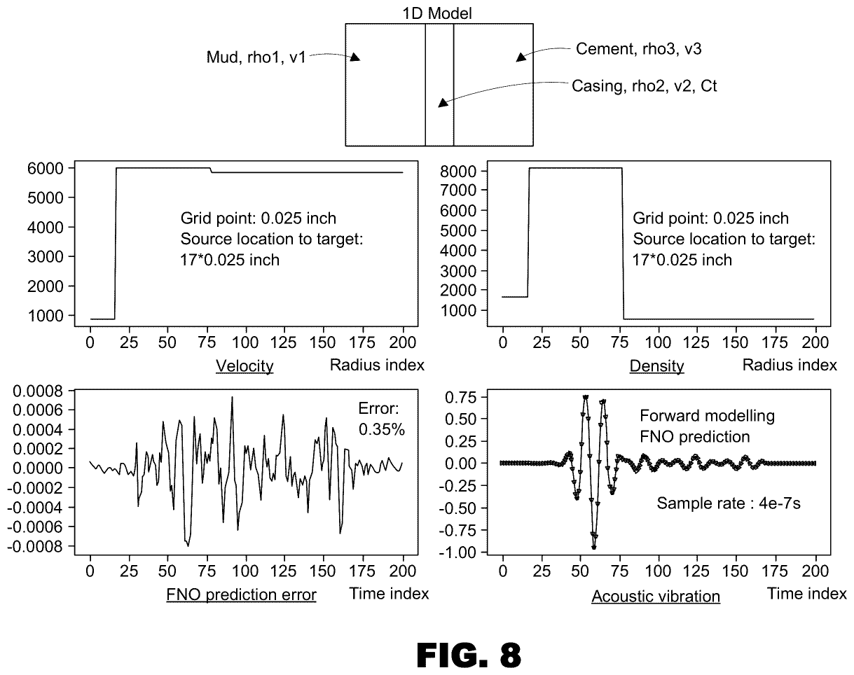

FIG. 8 illustrates an example prediction generated by a proxy model for a borehole with a cemented casing. The example prediction in this example is in 1D. For example, the prediction can include a 1D planar model generated for the borehole with the cemented casing. In this example, the variables used in forward training of the proxy model can include the density and p-wave velocity of mud in the borehole; the density, p-wave velocity, and thickness of a steel casing, and the density and p-wave velocity of a cement annulus. The variables in FIG. 8 are merely illustrative examples provided for explanation purposes. In other examples, the variables used for forward training the proxy model can additionally or alternatively include other sample characteristics.

In some examples, the forward modeling results can be obtained from finite difference simulations, which can be used to train a network implemented by the proxy model, such as an FNO network. As shown in FIG. 8, the prediction results of the proxy model have a low error (high accuracy).

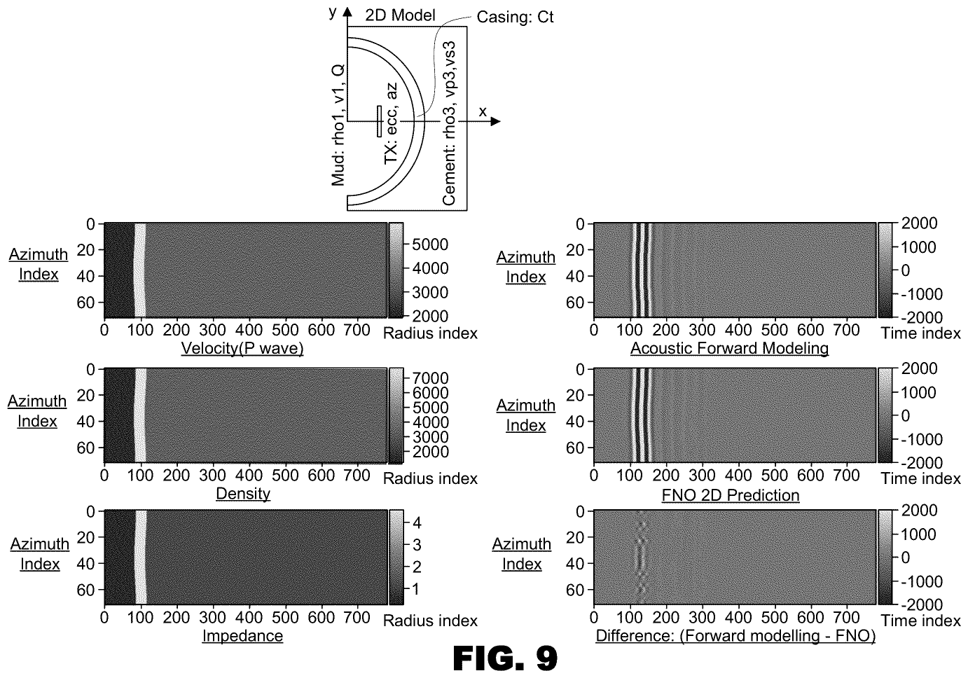

FIG. 9 illustrates an example validation result of an ultrasonic waveform predicted by an FNO/FNN in a generalized 2D case hole model. The 2D case hole model is similar to a three-dimensional (3D) geometry acquired in the real-world (e.g., a real 3D geometry). In some cases, one or more additional variables can be used in the training of the model relative to the training of the model associated with the results in FIG. 8. For example, in some cases, an additional variable introduced in the training, as compared to the 1D case in FIG. 8, can include the eccentering of a transceiver in the borehole with various firing angles. Mud attenuation and potential s-wave velocity of the annular medium can also be considered.

With sufficient forward modeling training, the FNO/FNN can accurately predict the main echo and resonance characteristics of an ultrasonic waveform. During field acquisition, mud properties, casing steel properties, and tool position are generally known or can be measured. Thus, the FNO/FNN can accurately map annular material properties to a measured ultrasonic wave response in the cased-hole example.

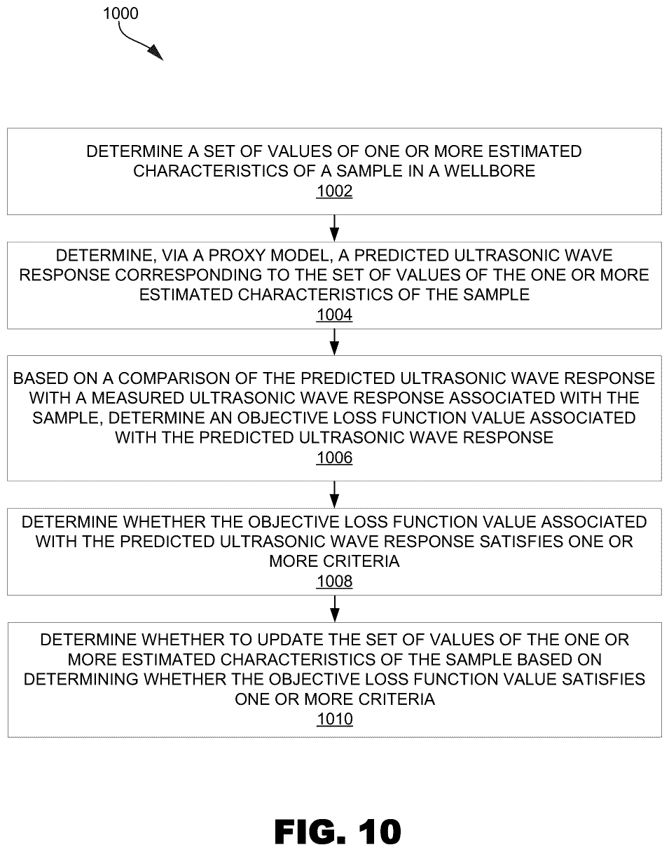

FIG. 10 is a flowchart illustrating an example process 1000 for predicting characteristics of a sample, such as a geometry, material properties, etc. At block 1002, the process 1000 can include determining a set of values of one or more estimated characteristics of a sample in a wellbore. The set of values of one or more estimated characteristics of a sample can include a distribution of characteristics, material property values, geometry values, a material function, etc. The sample can include one or more materials, structures, objects, etc. For example, the sample can include a casing, a cement portion and/or structure in a borehole, mud, a rock formation, liquid, a tool, one or more elements, and/or any other material, structure, substance, and/or object.

At block 1004, the process 1000 can include determining, via a proxy model, a predicted ultrasonic wave response corresponding to the set of values of the one or more estimated characteristics of the sample. For example, the proxy model can generate the predicted ultrasonic wave response corresponding to the set of values of the one or more estimated characteristics, which can represent a predicted ultrasonic pulse echo response (e.g., a physical response) of the sample. In some examples, the proxy model can include an artificial intelligence (AI) or machine learning (ML) model. For example, the proxy model can include an FNO, an FNN, a U-Net network, a PCA-ANN, a PINO, or a PINN.

In some aspects, determining the predicted ultrasonic wave response can include generating, based on the set of values, a first function in a first domain; and converting, using the proxy model, the first function from the first domain to a second function in a second domain. In some cases, the first domain can include a spatial domain and the second domain can include a frequency domain.

In some examples, the one or more estimated characteristics of the sample can include material properties of the sample. In some aspects, determining the predicted ultrasonic wave response can include transforming the set of values from a domain associated with the material properties to a different domain associated with a waveform.

At block 1006, the process 1000 can include based on a comparison of the predicted ultrasonic wave response with a measured ultrasonic wave response associated with the sample, determining an objective loss function value associated with the predicted ultrasonic wave response. The measured ultrasonic wave response can include a measured physical response obtained from the sample using an ultrasonic sensing system. For example, in some cases, the measured ultrasonic wave response can include a measured physical response obtained from the sample using ultrasonic pulse echo. In some aspects, the process 1000 can include comparing the predicted ultrasonic wave response with the measured ultrasonic wave response, and determining the objective loss function value based on any differences between the predicted ultrasonic wave response and the measured ultrasonic wave response.

At block 1008, the process 1000 can include determining whether the objective loss function value associated with the predicted ultrasonic wave response satisfies one or more criteria. In some examples, the one or more criteria can include a first criteria that the objective loss function value be below a first threshold, a second criteria that a slope of the objective loss function value be below a second threshold, a third criteria specifying a reduction of a number of processing iterations (e.g., that the number of iterations is maximized), and/or a fourth criteria specifying that an error represented by the objective loss function value be below a threshold.

If the objective loss function value does not satisfy the one or more criteria it can mean that the set of values of the one or more estimated characteristics of the sample used to generate the predicted ultrasonic wave response are inaccurate, have a certain amount of inaccuracy, and/or have a certain probability of being inaccurate. If the objective loss function value does satisfy the one or more criteria it can mean that the set of values of the one or more estimated characteristics of the sample used to generate the predicted ultrasonic wave response are accurate, have a threshold accuracy, and/or have a certain probability of being accurate.

In some examples, if the objective loss function value indicates that an error is above a threshold, it can mean that the set of values of the one or more estimated characteristics of the sample used to generate the predicted ultrasonic wave response are inaccurate, have a certain amount of inaccuracy, and/or have a certain probability of being inaccurate. On the other hand, if the objective loss function value indicates that an error is below the threshold, it can mean that the set of values of the one or more estimated characteristics of the sample used to generate the predicted ultrasonic wave response are accurate, have a threshold accuracy, and/or have a certain probability of being accurate.

At block 1010, the process 1000 can include determining whether to update the set of values of the one or more estimated characteristics of the sample based on determining whether the objective loss function value satisfies the one or more criteria.

In some examples, determining whether to update the set of values of the one or more estimated characteristics of the sample can include determining that the set of values is below a threshold; and in response to determining that the set of values is below the threshold, generating an indication that the one or more estimated characteristics of the sample are correct.

In some examples, determining whether to update the set of values of the one or more estimated characteristics of the sample can include determining that the set of values is not below a threshold; in response to determining that the set of values is not below the threshold, updating the set of values; determining, via the proxy model, an additional predicted ultrasonic wave response corresponding to the updated set of values; based on a comparison of the additional predicted ultrasonic wave response with the measured ultrasonic wave response, determining an additional objective loss function value associated with the additional predicted ultrasonic wave response; and determining whether the additional objective loss function value associated with the additional predicted ultrasonic wave response satisfies the one or more criteria. In some cases, the updated set of values can correspond to one or more updated characteristics of the sample. In some aspects, the process 1000 can include determining, based on the determining whether the additional objective loss function value satisfies the one or more criteria, whether to update the updated set of values of the one or more updated characteristics of the sample and generate a respective predicted ultrasonic wave response.

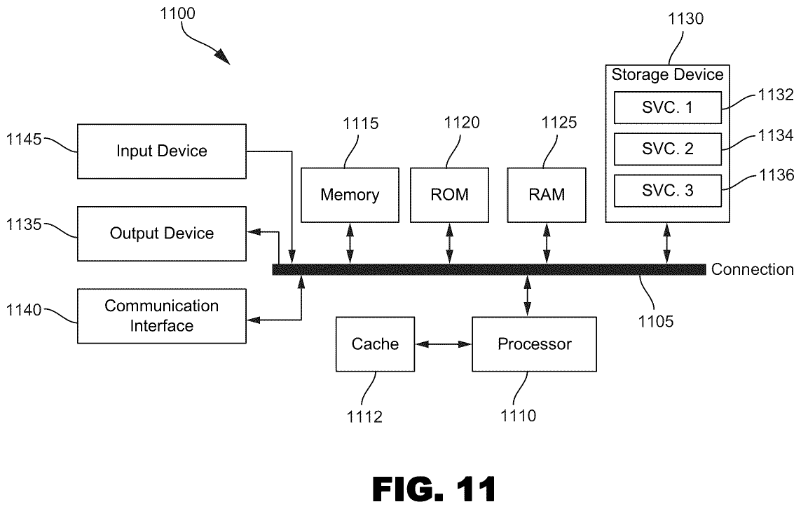

FIG. 11 illustrates an example computing device architecture 1100 which can be employed to perform any of the systems and techniques described herein. In some examples, the computing device architecture can be integrated with the electromagnetic imager tools described herein. Further, the computing device can be configured to implement the techniques of controlling borehole image blending through machine learning described herein.

The components of the computing device architecture 1100 are shown in electrical communication with each other using a connection 1105, such as a bus. The example computing device architecture 1100 includes a processing unit (CPU or processor) 1110 and a computing device connection 1105 that couples various computing device components including the computing device memory 1115, such as read only memory (ROM) 1120 and random-access memory (RAM) 1125, to the processor 1110.

The computing device architecture 1100 can include a cache of high-speed memory connected directly with, in close proximity to, or integrated as part of the processor 1110. The computing device architecture 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other computing device memory 1115 may be available for use as well. The memory 1115 can include multiple different types of memory with different performance characteristics. The processor 1110 can include any general-purpose processor and a hardware or software service, such as service 1 1132, service 2 1134, and service 3 1136 stored in storage device 1130, configured to control the processor 1110 as well as a special-purpose processor where software instructions are incorporated into the processor design. The processor 1110 may be a self-contained system, containing multiple cores or processors, a bus, memory controller, cache, etc. A multi-core processor may be symmetric or asymmetric.

To enable user interaction with the computing device architecture 1100, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art, such as a display, projector, television, speaker device, etc. In some instances, multimodal computing devices can enable a user to provide multiple types of input to communicate with the computing device architecture 1100. The communications interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. The storage device 1130 can include services 1132, 1134, 1136 for controlling the processor 1110. Other hardware or software modules are contemplated. The storage device 1130 can be connected to the computing device connection 1105. In one aspect, a hardware module that performs a particular function can include the software component stored in a computer-readable medium in connection with the necessary hardware components, such as the processor 1110, connection 1105, output device 1135, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A method comprising: determining a set of values of one or more estimated characteristics of a sample in a wellbore; determining, via a proxy model, a predicted ultrasonic wave response corresponding to the set of values of the one or more estimated characteristics of the sample; based on a comparison of the predicted ultrasonic wave response with a measured ultrasonic wave response associated with the sample, determining an error associated with the predicted ultrasonic wave response, the measured ultrasonic wave response being obtained using ultrasonic pulse echo; determining whether the error associated with the predicted ultrasonic wave response is below a threshold; and determining whether to update the set of values of the one or more estimated characteristics of the sample based on determining whether the error is below the threshold.

Aspect 2. The method of Aspect 1, wherein the proxy model comprises an artificial intelligence (AI) or machine learning (ML) model.

Aspect 3. The method of any of Aspects 1 to 2, wherein the proxy model comprises at least one of a Fourier neural operator (FNO), a Fourier neural network (FNN), a U-Net network, a principal component analysis (PCA) artificial neural network (ANN), a physics-informed neural operator (PINO), and a physics-informed neural network (PINN).

Aspect 4. The method of any of Aspects 1 to 3, wherein determining the predicted ultrasonic wave response comprises: based on the set of values, generating a first function in a first domain; and converting, using the proxy model, the first function from the first domain to a second function in a second domain.

Aspect 5. The method of Aspect 4, wherein the first domain comprises a spatial domain and the second domain comprises a frequency domain.

Aspect 6. The method of any of Aspects 1 to 5, wherein the one or more estimated characteristics of the sample comprise material properties, and wherein determining the predicted ultrasonic wave response comprises transforming the set of values from a domain associated with the material properties to a different domain associated with a waveform.

Aspect 7. The method of any of Aspects 1 to 6, wherein determining whether to update the set of values of the one or more estimated characteristics of the sample comprises: determining that the set of values is below the threshold; and in response to determining that the set of values is below the threshold, generating an indication that the one or more estimated characteristics of the sample are correct.

Aspect 8. The method of any of Aspects 1 to 7, wherein determining whether to update the set of values of the one or more estimated characteristics of the sample comprises: determining that the set of values is not below the threshold; in response to determining that the set of values is not below the threshold, updating the set of values, wherein the updated set of values correspond to one or more updated characteristics of the sample; determining, via the proxy model, an additional predicted ultrasonic wave response corresponding to the updated set of values of the one or more updated characteristics of the sample; based on a comparison of the additional predicted ultrasonic wave response with the measured ultrasonic wave response, determining an additional error associated with the additional predicted ultrasonic wave response; and determining whether the additional error associated with the additional predicted ultrasonic wave response is below the threshold.

Aspect 9. The method of any of Aspects 1 to 8, further comprising determining, based on the determining whether the additional error is below the threshold, whether to update the updated set of values of the one or more updated characteristics of the sample and generate a respective predicted ultrasonic wave response.

Aspect 10. The method of any of Aspects 1 to 9, wherein the one or more estimated characteristics of the sample comprise at least one of a density, a geometry, a thickness, and an elastic velocity.

Aspect 11. A system comprising: a memory; and one or more processors coupled to the memory, the one or more processors configured to: determine a set of values of one or more estimated characteristics of a sample in a wellbore; determine, via a proxy model, a predicted ultrasonic wave response corresponding to the set of values of the one or more estimated characteristics of the sample; based on a comparison of the predicted ultrasonic wave response with a measured ultrasonic wave response associated with the sample, determine an error associated with the predicted ultrasonic wave response, the measured ultrasonic wave response being obtained using ultrasonic pulse echo; determine whether the error associated with the predicted ultrasonic wave response is below a threshold; and determine whether to update the set of values of the one or more estimated characteristics of the sample based on determining whether the error is below the threshold.

Aspect 12. The system of Aspect 11, wherein the proxy model comprises an artificial intelligence (AI) or machine learning (ML) model.

Aspect 13. The system of any of Aspects 11 to 12, wherein the proxy model comprises at least one of a Fourier neural operator (FNO), a Fourier neural network (FNN), a U-Net network, a principal component analysis (PCA) artificial neural network (ANN), a physics-informed neural operator (PINO), and a physics-informed neural network (PINN).

Aspect 14. The system of any of Aspects 11 to 13, wherein determining the predicted ultrasonic wave response comprises: based on the set of values, generating a first function in a first domain; and converting, using the proxy model, the first function from the first domain to a second function in a second domain.

Aspect 15. The system of Aspect 14, wherein the first domain comprises a spatial domain and the second domain comprises a frequency domain.

Aspect 16. The system of any of Aspects 11 to 15, wherein the one or more estimated characteristics of the sample comprise material properties, and wherein determining the predicted ultrasonic wave response comprises transforming the set of values from a domain associated with the material properties to a different domain associated with a waveform.

Aspect 17. The system of any of Aspects 11 to 16, wherein determining whether to update the set of values of the one or more estimated characteristics of the sample comprises: determining that the set of values is below the threshold; and in response to determining that the set of values is below the threshold, generating an indication that the one or more estimated characteristics of the sample are correct.

Aspect 18. The system of any of Aspects 11 to 17, wherein determining whether to update the set of values of the one or more estimated characteristics of the sample comprises: determining that the set of values is not below the threshold; in response to determining that the set of values is not below the threshold, updating the set of values, wherein the updated set of values correspond to one or more updated characteristics of the sample; determining, via the proxy model, an additional predicted ultrasonic wave response corresponding to the updated set of values of the one or more updated characteristics of the sample; based on a comparison of the additional predicted ultrasonic wave response with the measured ultrasonic wave response, determining an additional error associated with the additional predicted ultrasonic wave response; and determining whether the additional error associated with the additional predicted ultrasonic wave response is below the threshold.

Aspect 19. The system of any of Aspects 11 to 18, wherein the one or more processors are configured to determine, based on the determining whether the additional error is below the threshold, whether to update the updated set of values of the one or more updated characteristics of the sample and generate a respective predicted ultrasonic wave response.

Aspect 20. The system of any of Aspects 11 to 19, wherein the one or more estimated characteristics of the sample comprise at least one of a density, a geometry, a thickness, and an elastic velocity.

Aspect 21. A non-transitory computer-readable storage medium having stored thereon instructions which, when executed by one or more processors, cause the one or more processors to: determine a set of values of one or more estimated characteristics of a sample in a wellbore; determine, via a proxy model, a predicted ultrasonic wave response corresponding to the set of values of the one or more estimated characteristics of the sample; based on a comparison of the predicted ultrasonic wave response with a measured ultrasonic wave response associated with the sample, determine an error associated with the predicted ultrasonic wave response, the measured ultrasonic wave response being obtained using ultrasonic pulse echo; determine whether the error associated with the predicted ultrasonic wave response is below a threshold; and determine whether to update the set of values of the one or more estimated characteristics of the sample based on determining whether the error is below the threshold.

Aspect 22. The non-transitory computer-readable storage medium of Aspect 21, wherein the proxy model comprises an artificial intelligence (AI) or machine learning (ML) model.

Aspect 23. The non-transitory computer-readable storage medium of any of Aspects 21 to 22, wherein the proxy model comprises at least one of a Fourier neural operator (FNO), a Fourier neural network (FNN), a U-Net network, a principal component analysis (PCA) artificial neural network (ANN), a physics-informed neural operator (PINO), and a physics-informed neural network (PINN).

Aspect 24. The non-transitory computer-readable storage medium of any of Aspects 21 to 23, wherein determining the predicted ultrasonic wave response comprises: based on the set of values, generating a first function in a first domain; and converting, using the proxy model, the first function from the first domain to a second function in a second domain.

Aspect 25. The non-transitory computer-readable storage medium of Aspect 24, wherein the first domain comprises a spatial domain and the second domain comprises a frequency domain.

Aspect 26. The non-transitory computer-readable storage medium of any of Aspects 21 to 25, wherein the one or more estimated characteristics of the sample comprise material properties, and wherein determining the predicted ultrasonic wave response comprises transforming the set of values from a domain associated with the material properties to a different domain associated with a waveform.

Aspect 27. The non-transitory computer-readable storage medium of any of Aspects 21 to 26, wherein determining whether to update the set of values of the one or more estimated characteristics of the sample comprises: determining that the set of values is below the threshold; and in response to determining that the set of values is below the threshold, generating an indication that the one or more estimated characteristics of the sample are correct.

Aspect 28. The non-transitory computer-readable storage medium of any of Aspects 21 to 26, wherein determining whether to update the set of values of the one or more estimated characteristics of the sample comprises: determining that the set of values is not below the threshold; in response to determining that the set of values is not below the threshold, updating the set of values, wherein the updated set of values correspond to one or more updated characteristics of the sample; determining, via the proxy model, an additional predicted ultrasonic wave response corresponding to the updated set of values of the one or more updated characteristics of the sample; based on a comparison of the additional predicted ultrasonic wave response with the measured ultrasonic wave response, determining an additional error associated with the additional predicted ultrasonic wave response; and determining whether the additional error associated with the additional predicted ultrasonic wave response is below the threshold.

Aspect 29. The non-transitory computer-readable storage medium of any of Aspects 21 to 28, having stored thereon instructions which, when executed by the one or more processors, cause the one or more processors to determine, based on the determining whether the additional error is below the threshold, whether to update the updated set of values of the one or more updated characteristics of the sample and generate a respective predicted ultrasonic wave response.

Aspect 30. The non-transitory computer-readable storage medium of any of Aspects 21 to 29, wherein the one or more estimated characteristics of the sample comprise at least one of a density, a geometry, a thickness, and an elastic velocity.

Aspect 31. A system comprising means for performing a method according to any of Aspects 1 to 10.

What is claimed is:

1. A method comprising:
determining a set of values of one or more estimated characteristics of a sample in a wellbore;
determining, via a proxy model, a predicted ultrasonic wave response corresponding to the set of values of the one or more estimated characteristics of the sample;
based on a comparison of the predicted ultrasonic wave response with a measured ultrasonic wave response associated with the sample, determining an objective loss function value associated with the predicted ultrasonic wave response, the measured ultrasonic wave response being obtained using an ultrasonic sensing system, wherein the objective loss function value contains or represents a misfit between the predicted ultrasonic wave response and the measured ultrasonic wave response associated with the sample;
determining whether the objective loss function value satisfies one or more criteria, wherein the one or more criteria comprises at least one of a first criteria that the objective loss function value be below a first threshold, a second criteria that a slope of the objective loss function value be below a second threshold, and a third criteria specifying a reduction of a number of processing iterations; and
determining whether to update the set of values of the one or more estimated characteristics of the sample based on determining whether the objective loss function value satisfies the one or more criteria.

2. The method of claim 1, wherein the proxy model comprises an artificial intelligence (AI) or machine learning (ML) model.

3. The method of claim 1, wherein the proxy model comprises at least one of a Fourier neural operator (FNO), a Fourier neural network (FNN), a U-Net network, a principal component analysis (PCA) artificial neural network (ANN), a physics-informed neural operator (PINO), and a physics-informed neural network (PINN).

4. The method of claim 1, wherein determining the predicted ultrasonic wave response comprises:
based on the set of values, generating a first function in a first domain; and
converting, using the proxy model, the first function from the first domain to a second function in a second domain.

5. The method of claim 4, wherein the first domain comprises a spatial domain and the second domain comprises a frequency domain.

6. The method of claim 1, wherein the one or more estimated characteristics of the sample comprise material properties, and wherein determining the predicted ultrasonic wave response comprises transforming the set of values from a domain associated with the material properties to a different domain associated with a waveform.

7. The method of claim 1, wherein determining whether to update the set of values of the one or more estimated characteristics of the sample comprises:
determining that the set of values is below a threshold; and
in response to determining that the set of values is below the threshold, generating an indication that the one or more estimated characteristics of the sample are correct.

8. The method of claim 1, wherein determining whether to update the set of values of the one or more estimated characteristics of the sample comprises:
determining that the set of values is not below a threshold;
in response to determining that the set of values is not below the threshold, updating the set of values, wherein the updated set of values correspond to one or more updated characteristics of the sample;
determining, via the proxy model, an additional predicted ultrasonic wave response corresponding to the updated set of values of the one or more updated characteristics of the sample;
based on a comparison of the additional predicted ultrasonic wave response with the measured ultrasonic wave response, determining an additional objective loss function value associated with the additional predicted ultrasonic wave response; and
determining whether the additional objective loss function value associated with the additional predicted ultrasonic wave response satisfies the one or more criteria.

9. The method of claim 8, further comprising determining, based on the determining whether the additional objective loss function value satisfies the one or more criteria, whether to update the updated set of values of the one or more updated characteristics of the sample and generate a respective predicted ultrasonic wave response.

10. The method of claim 1, wherein the one or more estimated characteristics of the sample comprise at least one of a density, a geometry, a thickness, and an elastic velocity.

11. A system comprising:
a memory; and
one or more processors coupled to the memory, the one or more processors configured to:
determine a set of values of one or more estimated characteristics of a sample in a wellbore;
determine, via a proxy model, a predicted ultrasonic wave response corresponding to the set of values of the one or more estimated characteristics of the sample;
based on a comparison of the predicted ultrasonic wave response with a measured ultrasonic wave response associated with the sample, determine an objective loss function value associated with the predicted ultrasonic wave response, the measured ultrasonic wave response being obtained using an ultrasonic sensing system, wherein the objective loss function value contains or represents a misfit between the predicted ultrasonic wave response and the measured ultrasonic wave response associated with the sample;
determine whether the objective loss function value satisfies one or more criteria, wherein the one or more criteria comprises at least one of a first criteria that the objective loss function value be below a first threshold, a second criteria that a slope of the objective loss function value be below a second threshold, and a third criteria specifying a reduction of a number of processing iterations; and
determine whether to update the set of values of the one or more estimated characteristics of the sample based on determining whether the objective loss function value satisfies the one or more criteria.

12. The system of claim 11, wherein the proxy model comprises an artificial intelligence (AI) or machine learning (ML) model.

13. The system of claim 11, wherein the proxy model comprises at least one of a Fourier neural operator (FNO), a Fourier neural network (FNN), a U-Net network, a principal component analysis (PCA) artificial neural network (ANN), a physics-informed neural operator (PINO), and a physics-informed neural network (PINN).

14. The system of claim 11, wherein determining the predicted ultrasonic wave response comprises:
based on the set of values, generating a first function in a first domain; and
converting, using the proxy model, the first function from the first domain to a second function in a second domain.

15. The system of claim 14, wherein the first domain comprises a spatial domain and the second domain comprises a frequency domain.

16. The system of claim 11, wherein the one or more estimated characteristics of the sample comprise material properties, and wherein determining the predicted ultrasonic wave response comprises transforming the set of values from a domain associated with the material properties to a different domain associated with a waveform.

17. The system of claim 11, wherein determining whether to update the set of values of the one or more estimated characteristics of the sample comprises:
determining that the set of values is below a threshold; and
in response to determining that the set of values is below the threshold, generating an indication that the one or more estimated characteristics of the sample are correct.

18. The system of claim 11, wherein determining whether to update the set of values of the one or more estimated characteristics of the sample comprises:
determining that the set of values is not below a threshold;
in response to determining that the set of values is not below the threshold, updating the set of values, wherein the updated set of values correspond to one or more updated characteristics of the sample;
determining, via the proxy model, an additional predicted ultrasonic wave response corresponding to the updated set of values of the one or more updated characteristics of the sample;
based on a comparison of the additional predicted ultrasonic wave response with the measured ultrasonic wave response, determining an additional objective loss function value associated with the additional predicted ultrasonic wave response; and
determining whether the additional objective loss function value associated with the additional predicted ultrasonic wave response satisfies the one or more criteria.

19. The system of claim 18, wherein the one or more processors are configured to determine, based on the determining whether the additional objective loss function value satisfies the one or more criteria, whether to update the updated set of values of the one or more updated characteristics of the sample and generate a respective predicted ultrasonic wave response.

20. A non-transitory computer-readable storage medium having stored thereon instructions which, when executed by one or more processors, cause the one or more processors to:
determine a set of values of one or more estimated characteristics of a sample in a wellbore;
determine, via a proxy model, a predicted ultrasonic wave response corresponding to the set of values of the one or more estimated characteristics of the sample;
based on a comparison of the predicted ultrasonic wave response with a measured ultrasonic wave response associated with the sample, determine an objective loss function value associated with the predicted ultrasonic wave response, the measured ultrasonic wave response being obtained using an ultrasonic sensing system, wherein the objective loss function value contains or represents a misfit between the predicted ultrasonic wave response and the measured ultrasonic wave response associated with the sample;
determine whether the objective loss function value associated with the predicted ultrasonic wave response satisfies the one or more criteria, wherein the one or more criteria comprises at least one of a first criteria that the objective loss function value be below a first threshold, a second criteria that a slope of the objective loss function value be below a second threshold, and a third criteria specifying a reduction of a number of processing iterations; and
determine whether to update the set of values of the one or more estimated characteristics of the sample based on determining whether the objective loss function value satisfies the one or more criteria.
